(19) United States
(12) Patent Application Publication
(10) Pub. No.: US 2013/0282466 A1
(43) Pub. Date: Oct. 24, 2013

(54) SYSTEMS AND METHODS FOR GENERATION OF AN ONLINE STORE

(71) Applicant: Global Village Concerns, San Diego, CA (US)

(72) Inventor: George P. Hampton, San Diego, CA (US)

(21) Appl. No.: 13/840,620

(22) Filed: Mar. 15, 2013

Related U.S. Application Data
(63) Continuation-in-part of application No. 13/756,510, filed on Jan. 31, 2013.
(60) Provisional application No. 61/593,287, filed on Jan. 31, 2012.

(51) Int. Cl. G06Q 30/06

(52) U.S. Cl. CPC G06Q 30/0633
USPC 705/14.27; 705/26.8

(57) ABSTRACT

A method for implementing an online teacher gift registry includes: generating a teacher registration graphical user interface; entering teacher registration information prompted by a registration module; selecting, from an online store, products and a quantity of each of the selected products to be included in the teacher gift registry for others to purchase; and electronically publishing registry information. The electronically published registry information includes a uniform resource locator (URL) link enabling others to access the teacher gift registry.

### RELATED APPLICATIONS INFORMATION

This application is a continuation-in-part application of U.S. application Ser. No. 13/756,510, filed Jan. 31, 2013, which claims the benefit of priority under 35 U.S.C. §119(e) of U.S. Provisional Application Ser. No. 61/593,287 filed Jan. 31, 2012 and entitled “System and Methods for Online Branding and Fundraising,” which is incorporated herein by reference in its entirety as if set forth in full.

### FIELD OF THE INVENTION

The systems and methods disclosed herein relate generally to branding and promotional and fundraising programs for schools and other organizations or communities, and in particular, to a platform for facilitating and automating such programs for a plurality of organizations.

### BACKGROUND

Conventionally, if a school or other organization or community desired to raise funds, they would often need to create branding (e.g., a logo), create branded products (e.g., clothing, accessories, etc.), and then promote the sale of these products for themselves, while potentially maintaining an inventory of the products. Often, the school or organization cannot afford the services of marketing professionals to aid in the creation of compelling merchandise and marketing. This typically results in sub-optimal fundraising.

### SUMMARY

Accordingly, the disclosed systems and methods fundamentally shift the way in which such organizations raise funds, while increasing visibility and community support by offering a unique social e-commerce platform that leverages online social tools to more effectively raise funds as well as provide for donations of classroom supplies. In embodiments, the disclosed platforms allow for easy, automated creation of brands, merchandise, and online stores. The platform also provides a mechanism to track purchases, customers, and relationships, send reminders, suggestions, and other messages, and further increase fundraising while providing a satisfying customer or purchaser experience.

According to one aspect, a system for automatic generation of a school store front, comprises storage configured to store: a plurality of school store front templates, and at least one base product catalogue; and an administration module comprising store front creation module, the store front creation module configured to receive a selection of one of the plurality of store front templates, receive school-specific variables, receive a selection of artwork associated with the school, and generate a school specific catalogue from the base catalogue using the selected artwork and the school-specific variables.

According to another aspect, a system for automatic generation of an school store front, comprises storage configured to store: a plurality of school store front templates, and at least one base product catalogue; an administration module comprising store front creation module, the store front creation module configured to receive a selection of one of the plurality of store front templates, receive school-specific variables, receive a selection of artwork associated with the school, and generate a school specific catalogue from the base catalogue using the selected artwork and the school-specific variables; a web server, and wherein the administration module is configured to publish the school store front via the web server; an account generation module configured to allow students to create accounts associated with the store front; and a registry generation module configured to enable a plurality of students to create a plurality of registries associated with the school store front by selecting items from the school specific catalogue, providing or uploading contact information, and wherein the registry module will add the selected items to the associated student registry and send a message to contacts included in the contact information providing a link to the associated student registry.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a process flow for creating and serving a custom product catalog, according to an embodiment;

FIGS. 2 and 3 illustrates a taxonomy for an artwork naming scheme, according to an embodiment;

FIG. 4 illustrates a product file naming scheme, according to an embodiment;

FIG. 5 illustrates a file and directory naming scheme, according to an embodiment;

FIGS. 6 and 7 illustrate the generation of custom product images, according to an embodiment;

FIGS. 8-10 illustrate a file and directory naming scheme, according to an embodiment;

FIG. 11 illustrates a process for generation of custom product images, according to an embodiment;

FIG. 12 illustrates some example database tables, according to an embodiment;

FIG. 13 illustrates a method for creating a custom online store, according to an embodiment;

FIG. 14 illustrates a method for registration, according to an embodiment;

FIG. 15 illustrates an example computing system which may be used with embodiments of the methods and systems disclosed herein, according to an embodiment;

FIG. 16 illustrates some example logos generated in accordance to one embodiment;

FIGS. 17-22 illustrate before and after images for the logos in FIG. 16;

FIG. 23 illustrates a graphical user interface according to an example embodiment of the present inventive concept;

FIG. 24 illustrates a search page of a user interface according to an example embodiment of the present inventive concept; and

FIG. 25 illustrates a process of creating and using a teacher registry according to an example embodiment of the present inventive concept.

### DETAILED DESCRIPTION

In an embodiment, the disclosed systems and methods enable the creation of customized storefronts for organizations, such as schools, non-profits, teams and leagues, churches/synagogues, military with customized and branded merchandise. Each storefront can have a custom theme with a customized look and feel, based on a specified configuration.

It will be understood that the stickiest social network is the family. The systems and methods herein, at least for example when implemented within a school environment tap into this network to ensure that the student has all of the supplies and gear they need, allow family and friends to more easily show support through purchase of school branded gear for themselves, and drives more business through the school store in order to drive revenue for the school and its programs.

As will be explained in detail below, the systems and methods described herein allow a school administrator or agent to quickly and efficiently generate a new, exciting logo and brand and create an online store with a plurality of products, supplies, equipment, etc., to which the new logo can be applied. Students can then create an account, provide the contact information for friends and family, or have their contacts automatically uploaded, and create a registry of needed or desired supplies and products.

Their contacts will then get an email informing them of the registry and providing a link so they can access the student's registry, browse the store and make purchases for the student of themselves. Moreover, the system can send additional emails before the student's birthday, holidays, a big event, etc. These additional emails can include suggestions either from the student's registry or just from the site.

In this way, e.g., schools can quickly and efficiently launch online stores, with fresh branding and up to date products. The schools can also more effectively reach the student's networks and drive more traffic to the store. The school would then typically receive a percentage of every purchase.

It should also be noted that fundraising can also be more easily run through the store by sending messages to the networks of the students, e.g., if permission to do so has been granted, by simply including information within the online store about the fundraiser, or both. In short, the student's networks will become the school's network.

Websites and Storefronts

In an embodiment, the system allows the establishment of a website and store for each of a plurality of different and possibly unrelated organizations. Each website and store may be hosted on the same server, set of servers, or set of cloud instances (e.g., virtual machines in a multi-tenant infrastructure). Each website and store may be accessible using the same base Uniform Resource Locator (URL) but with different paths. For example, the website for a first organization may be addressed by “http://www.baseurl.com/firstorg/” and the store for the organization may be addressed by “http://www.baseurl.com/firstorg/store/”. The website for a second organization may be addressed by “http://www.baseurl.com/secondorg/” with its store at “http://www.baseurl.com/secondorg/store/”. Alternatively, each website and store may be accessible via a unique URL.

In an embodiment, a router module or process allows clean URL redirection to each created website and storefront. For example, the router module may be configured to receive requests for the URL “http://store.example.com/”. If the router module receives a request for URL “http://store.example.com/store_id”, the router will perform a lookup on “store_id”. If the value of “store_id” matches a known storefront identifier (e.g., in a row of a database table), the router module will retrieve or redirect the request to the appropriate storefront webpage. If no match is found for the value of “store_id”, a default webpage, which may include an error message or other information, can be returned.

The storefronts and the use of registries, described in detail below, enable 24-hour revenue generation for participating organizations. Advantageously, this continuous or near-continuous revenue generation can be done with zero up-front or downstream costs to the organization. For example, a school can establish a website/storefront on the system and receive a portion (e.g., a percentage, such as 20%) of each purchase made through the school's associated storefront and/or registries. In this manner, the disclosed systems and methods provide turn-key fundraising for organizations, such as schools, including sub-organizations, such as—in the case of a school—sports, music, drama, art, and the like.

An administrative module allows the creation of new websites and/or stores for organizations. The administrative module may comprise a multi-store module which allows the creation of a store view. The store view contains the data that is used to populate a new storefront, including colors, descriptions, contact information, and product image variations. In an embodiment, a base store can be stored as a template, and accessed as a starting point or default position for a new organization's website/storefront. Different templates can be provided for different types of organizations. For example, a school template can comprise default school properties, such as a set of the most common school-specific variables (e.g., school name, school address, school logo, base URL for production-ready images, notification email templates, banners, product and shipping messages, etc.). The variables may also comprise default school colors, including background colors, front colors, accent colors, etc. When an administrator selects a base template to use, the administrator may be prompted to enter values for the school-specific variables or else accept default values, if available.

An administrator may be allowed to add, delete, or modify properties/variables of a template and/or website/storefront created from a template. An administrator may also be permitted to quickly enable and disable an organization's website/storefront, for example, by updating a status input (e.g., radio button, drop-down, etc.) associated with the website/storefront.

The administrative module may allow an administrator of the system to manage stores and manage art. If an administrator chooses to manage art, a user interface will be presented to the administrator for creating and managing art styles and layers, as well as any additional visual elements.

Individual websites and storefronts can be created using global system configuration items. In embodiments, where the websites and store fronts are for schools, these global system configuration items may include, without limitation, available school colors, possible mascots, highlight colors, possible image locations, font colors, etc.

A base catalog of configurable products can be created, imported into the system, or otherwise made available (e.g., through an interface with a separate or remote application or server) during the subsequent creation of storefronts. Each new storefront can comprise the entire base catalog, or a subset of the base catalog or other modified catalog derived from the base catalog. For instance, individual organizations may wish to exclude certain products in the base catalog from their particular storefront catalog, based on store requirements. A user interface can be provided to enable an administrator to select products for the storefront catalog and/or remove products from the storefront catalog.

A store object or objects representing each storefront can be stored in a database. The object can comprise one or more fields, including, without limitation, a storefront identifier, logo, title, whether or not the store is enabled, one or more colors, one or more highlight colors, one or more font colors, a list of excluded product identifiers, an image package identifier or archive, etc. It should be understood that additional or different fields may be included in the object. For example, instead of excluded product identifiers, the object can include product identifiers for those products which should be included in the storefront. In this manner, custom storefronts can be generated for each of a plurality of hosted storefronts. For example the store logo and store colors can be displayed based on the configuration of the store, as determined from the store object(s).

The storefront catalog can comprise products of different types (e.g., t-shirt, baby t-shirt, hat, fedora, etc.). Each product can be associated with options, modifiers, or other parameters, such as size, color, layout, branding/logo position, etc. Some or all of these parameters can be specific to the particular storefront, i.e., distinct from the parameters associated with other organizations' storefronts.

Each product can comprise a linked art style object, which determines what image is generated and displayed for the product in the storefront. The art style object can comprise a list of layer entities that may be used to transform base images in a product image package (i.e., product catalog) into a final, customized product image for a storefront. The art style object can be editable via an administrative module.

The list of layer entities in the art style object may comprise a list of layer object identifiers, enabling retrieval of layer objects (e.g., from a database). Each layer object can be a single transformation step that can be combined with other transformation steps via the art style object to contain all the transformation steps necessary to turn a base product image into a final product image that is specific and customized to a particular storefront's branding. Each layer object may comprise one or more fields, including, without limitation, an image name, scale, position, color, location, color exclusion, rotation, etc. The layer objects can be editable via the administrative module.

Each storefront and/or individual products within a storefront can be associated with an image package archive (e.g., a ZIP or TAR archive). The image package archive comprises the artwork needed to transform base product images into finalized product images which are specific to a storefront, using the art styles and layers in the art style object. For instance, the image package archive may comprise a ZIP file containing a single folder (or multiple folders) of images. Images can be named based on a predetermined naming convention to aid in the transformation of base images into finalized images. Image generation for the storefront, using the base image package, art style object, and image package archive, can be performed automatically by an image generation module, and may include caching with cache validation. In an embodiment, the images for select products can be regenerated. For instance, after a change to the art style object or image package archive, an administrator may wish to only regenerate images for a specific category of products (e.g., hats). An administrator can pass in a product collection to the storefront, and have the product items created based on the art style object and image package archive.

In an embodiment, a wizard can be provided for creating a new storefront. For example, in a first step, product categories can be selected. In a second step, colors can be selected. These first two steps are used to generate a product list comprising products selected by default. In a third step, a user can unselect products from the product list to be excluded from the storefront.

An administrator can select a default theme for a storefront. This theme may be selected from a plurality of predetermined and provided themes. However, a user interface may be provided which enables the administrator to override aspects (e.g., layout, colors, images, etc.) of the provided theme to create a custom theme for the storefront.

In an embodiment, an administrator can create, upload, or select a product image package. The product image can be named using one or more naming conventions to which all product image packages conform. By way of illustration only, an example naming scheme could name an image file such that the name comprises the product, organization, and associated art options (e.g., the file name may take the form of “[product identifier]_[organization identifier]_[art option identifier].jpg”). However, a mapping or other routing feature can be provided to map shorter format names to these long format names. The product image package identifies base products and associated options which should be included in a selected storefront. All stores can share the same base products, but have their own unique images. Images of the base products can be associated with default and/or customer options to generate the unique images for each storefront. For example, the system can comprise an image engine which retrieves a base product image, applies variable values set during the creation of the storefront (e.g., logos, colors, etc.) and/or applies default values for variables for which no value was set, and generates and returns the unique product image for the storefront. The unique product images can be stored on an image server.

The system can validate the existence of production-ready images for a storefront. For instance, the system can check the number of files, and the file names of image files on a product image server to make sure they match the product category for a particular store. The system can also verify that web-ready images are named correctly and match the corresponding product category. An error notification can be sent or displayed (e.g., to an administrator) if product images are missing.

In an embodiment, when a new storefront is created from a template store, base product categories can be duplicated from the template store. Applicable products can be assigned to the duplicated product category. An administrator can manually add, delete, and change the categories, as well as the products assigned to the categories.

Branding and Logo Creation

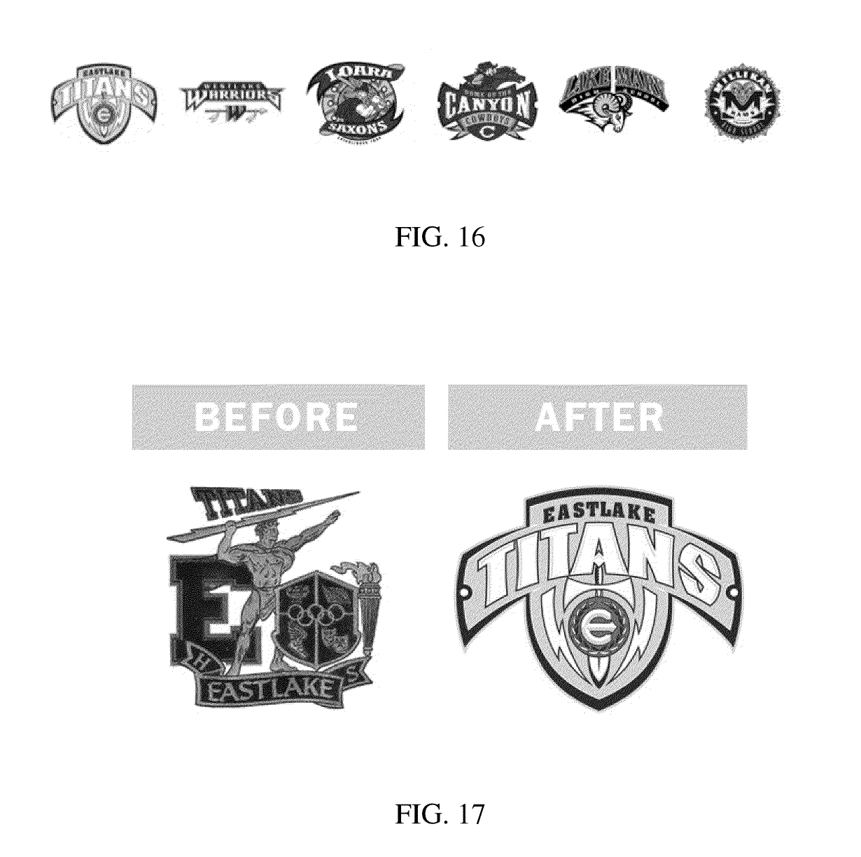

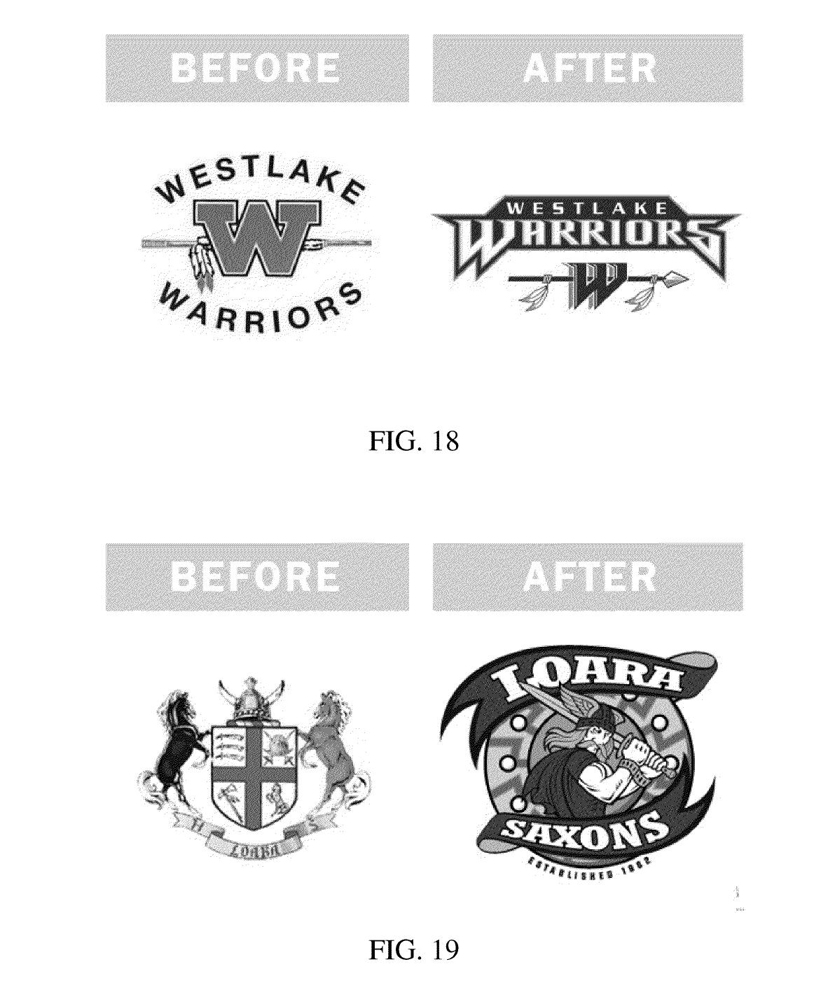

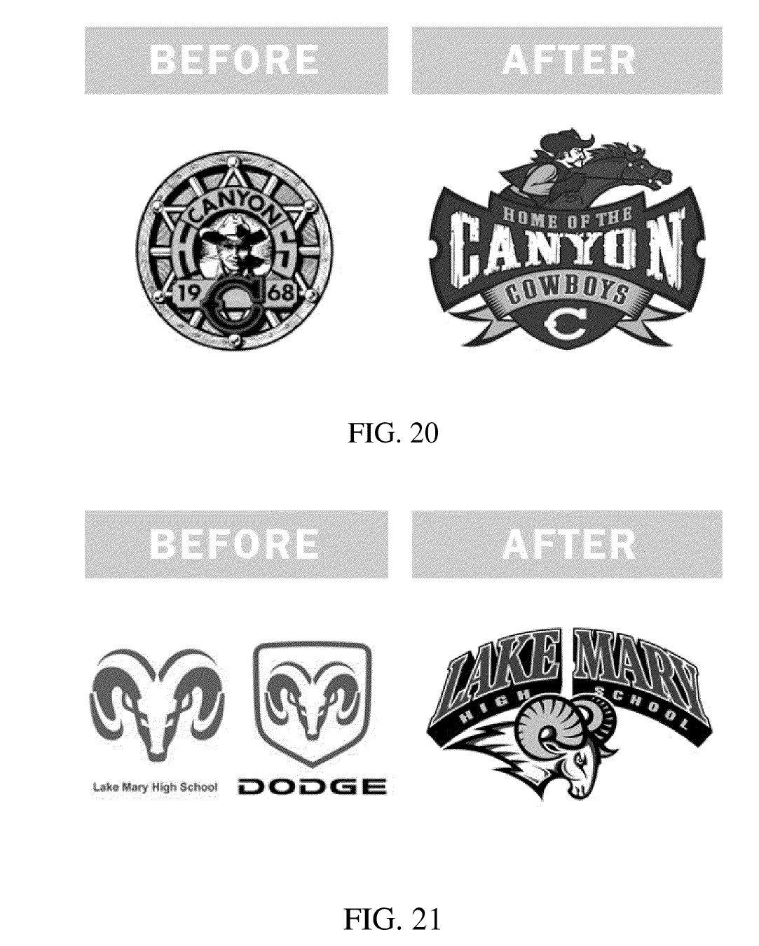

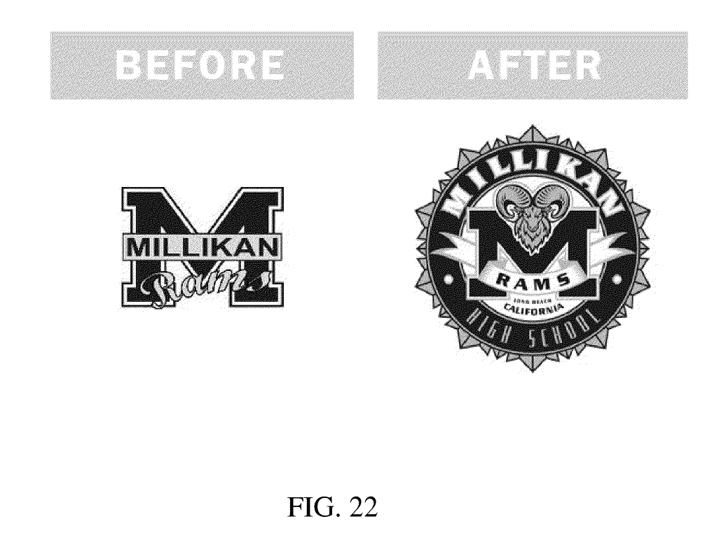

In certain embodiments, prior to store creation, a logo creation module can be configured to quickly create a new and exciting logo for the organization, e.g., school. A plurality of logo templates can be stored, where each template can comprise sub-templates. The templates can for example, comprise mascot images, such as eagles, pirates, Vikings, etc., as well as background components, e.g., crests, and text components. For example, FIG. 16 illustrates several example logos. The various components that make up these logos can be included within templates and sub-templates. A new, exciting logo can then quickly be created by selecting the templates and sub-templates as well as attributes such as color. FIGS. 17-22 illustrate the before and after for the logos of FIG. 16. The finished art work can then be saved as a file or resource for use with products in the store as described below.

Fundraiser Registration

The system may comprise a registration module which allows a user to register with an organization from the organization's website (e.g., home page). For example, the website may comprise an option to login or register with the website. If the user has previously registered and chooses to login, the user enters his or her username/email address and password to authenticate with the system, or uses some other standard or non-standard authentication method supported by the system (e.g., digital certificates, etc.).

If the user chooses to register with the website, the registration module provides a user interface which requests information from the registrant using one or more input fields (e.g., textboxes, drop-downs, buttons, radio buttons, checkboxes, text areas, etc.). For example, the registrant may be requested to provide a registration type using radio buttons or checkboxes associated with the possible registration types or a drop-down of registration types. In an embodiment in which the organization associated with the website is a school, the registration types may comprise a student registering for himself or herself, an adult registering for a student, and a non-student registering for himself or herself. In some embodiments, an adult must register for a student who is younger than a certain age (e.g., 12 years old or younger). In such embodiments, the student could register for himself or herself only if he or she is 13 years old or older.

If the registration type is for a registrant registering for himself or herself, the registrant may be prompted to enter his or her first and last names, email address, password and a password confirmation. In addition, the registrant may also be prompted to enter a username, or alternatively, the registrant's email address can be used instead of a separate username.

If the registration type is for an adult registering for a student or other person, the registrant may be prompted to enter additional information, such as the student's first and last names, gender, date of birth, clothing size(s), and class year (e.g., from a drop-down). In addition, the adult may be prompted or given an option to give the student or other person individual access by supplying a separate username/email address and/or password (e.g., with password confirmation) for the student or other person.

In addition, the registrant may be prompted to provide shipping information, contact information, and additional information. After registration is complete, an account confirmation email can be sent to the registrant. The email may include the first and last name of the registrant, the registrant's email address, password, welcome text, and/or a link to a login page for authenticating with the system.

Gift Registry Creation Process

The creation of the gift registry will now be described, according to an embodiment. A gift registry may be initiated manually by a fundraiser and/or be automatically created during the registration process (e.g., after the input of registration information as described above). For instance, after a fundraiser has registered with the system (e.g., via an organization website), a gift registry may automatically be created using default or pre-populated values (e.g., from previously input registration information). It should be understood that information about the fundraiser captured during the registration process can be passed to a gift registry module, which can use the information or store the information in associated tables. For example, the shipping address may default to the fundraiser's address. However, in an embodiment, the fundraiser's address remains hidden at all times from anyone other than the fundraiser and administrators with appropriate permissions. This is to ensure the fundraiser's privacy and security. When a donor purchases a gift from the registry, the shipping address may default to the shipping address for the fundraiser (but remain hidden from the donor). However, in an embodiment, when the donor purchases a gift that is not from the fundraiser's registry (e.g., a gift from the organization's storefront, but which the fundraiser did not add to his or her registry), the shipping address defaults to the donor's address. In either case, the donor can be given the option to change the shipping address.

In an embodiment, the donor may be required to login (or register if not already registered) in order to view and/or purchase gifts from a fundraiser's registry. Alternatively, this may not be required. According to an embodiment, users may also be permitted to search for gift registries (e.g., by a student's name). Alternatively, the user may only be permitted to search for gift registries with which he or she is associated (e.g., as a listed donor). These may be modifiable system settings, or may be settings which are modifiable by the fundraiser associated with the registry (e.g., during or after registry creation).

The fundraiser may select items to be included in his or her registry. The fundraiser may be directed to a men's or women's category based on the fundraiser's gender (e.g., as previously input during the registration process). The fundraiser may be presented with products which are available for his or her registry, for example, in a paged format. The products may be displayed as a list, grid, matrix, or in any other configuration. In an embodiment, the prices of the products are not displayed. In a further embodiment, the prices will not be displayed until the fundraiser has completed entering a profile, added at least a predetermined number of donors to the community, and added at least a predetermined number of items to his or her registry. As the fundraiser adds products to the registry, the selected products may be displayed in a separate frame or widget (e.g., on the left side of the user interface). Products may be displayed with the most recently added product displayed in the first (e.g., top) position. These selected products may comprise an image, name, and action inputs (e.g., an “x” button to delete the product from the registry, a drop down or other input to change the size of the product if relevant, and/or an input to change the quantity of the product). The fundraiser may also be able to specify a level of desire for each product (e.g., “like to have”, which may be a default, “want to have”, “need to have”, etc.)

The number of selected products displayed may be an administrative setting with a predetermined default. Alternatively or additionally, the frame comprising the selected products may display a set or predetermined number of products with a scroll bar, arrows, or pagination to view selected products beyond the set or predetermined number.

The user interface comprising the available products may also comprise a comparison link or button, which enables the user to compare multiple products to each other. For instance, the user may select multiple products (e.g., using checkboxes associated with the products) and then select a “compare” button, which displays product information for the selected products side-by-side or in some other configuration.

The user interface may also comprise a count of the total number of products or items added to the fundraiser's registry. A link may also be provided to allow the fundraiser to manage all products. Clicking on the link may direct the fundraiser to a view of all the products and items in his or her registry. This view may include pagination, with the total number of products per page comprising a user setting, administrative setting, or system setting, with a default (e.g., 30).

It should be appreciated that the fundraiser may be able to add products to his or her registry during the registration process, as well as subsequently from product list page(s). After a product has been added to a fundraiser's registry, the fundraiser's view of the product (e.g., on a product list page) may include an indication that the product is currently in the fundraiser's registry (e.g., by replacing an “add to registry” button with an “item added” indication). Otherwise, the fundraiser's view of the product (e.g., on a product list page) may provide an action button (e.g., an “add to registry” button) which allows the fundraiser to add the product to his or her registry. If the product is already in the fundraiser's registry, the product display may further comprise an input which permits the fundraiser to update a quantity of the product in the registry. As during registration, as a fundraiser adds products to his or her registry from the products list page, the added products may be displayed in a separate frame or widget (e.g., on the left side of the page) to differentiate the added products from those displayed as part of the store.

The products list page, both during registration and subsequent to registration, and for both fundraisers and donors, may display cross sale products (i.e., products of the same type as or recommended based on products already added to a registry or cart) on the page. For example, these products may be listed on the bottom or other portion of the page, and provide links to detailed product descriptions.

The system may comprise a gift registry module which provides a user interface to the fundraiser and donors comprising the fundraiser's gift registry both during the registration process and at any time subsequent to registration. The user interface may display the products in the fundraiser's gift registry in a list, grid, matrix, or other configuration. For each product, the user interface may provide an image of the product, a name of the product, a link to more details, a size (if relevant), a quantity desired, and a quantity purchased (or alternatively, a quantity remaining). In the fundraiser's view, the user interface may also provide a delete button for each product. In an embodiment, products are no longer displayed in the gift registry user interface if the quantity of products desired has been satisfied by a corresponding number of purchases/donations.

After the fundraiser has created his or her registry, the gift registry module may display the complete gift registry to the fundraiser, prior to moving to the next stage. The next stage may be to create a community of donors. Alternatively, the community may be created prior to creation of the registry, in which case, the next stage can be to share the gift registry. In an embodiment, the fundraiser must add a minimum number of items to his or her registry before proceeding to the next stage. This minimum may be an administrative or system setting, with a default (e.g., 5).

The community section can comprise a user interface which enables the fundraiser to enter contact information for potential donors. The interface may provide the fundraiser with email scraping choices or methods, by which contact information can be scraped from a third-party address book or contact list and imported into the fundraiser's community. This can be provided in addition to manual entry. The manual entry can comprise multiple input fields for each donor addition, including first and last names, email address, and relationship to the fundraiser. As potential donors are imported or manually added, the contact information can be added and displayed in the user interface, for example, in a separate frame or widget of the user interface. If a potential donor is imported (e.g., using an email scraper), inputs may be associated with the donor to collect additional information. For example, each imported donor displayed on the user interface may be associated with a relationship input (e.g., a drop-down), which allows the fundraiser to specify the relationship with the donor. Once a relationship is specified, the input can disappear. Each of the contacts, whether imported or manually added, can be associated with an edit link or button which allows the fundraiser to edit the contact. A delete link or button can also be associated with each of the contact to facilitate removal of donors from the community. Once the fundraiser has finished adding donors, he or she may select a link, button, or other input to indicate that the fundraiser has finished entering potential donors. In an embodiment, a minimum number of potential donors must be added before the community creation stage is complete. This number may be an administrative or system setting, with a default (e.g., 5).

In an embodiment, a fundraiser can share his or her gift registry during the registration process and/or subsequent to the registration process. The gift registry module can provide a user interface which allows the fundraiser to select community members from a list or directory, add donors, or specify other recipients of the fundraiser's registry. For instance, the user interface may permit the fundraiser to select community members or previously specified recipients using checkboxes, drop-downs, and the like. The user interface may also permit fundraisers to add new recipients (e.g., email addresses) to the share list of recipients. If a new recipient is added, the system can recognize whether the email address of the recipient already exists in the system for a registered donor. If not, the fundraiser can be provided with the option to add the recipient as a new donor, for example, by specifying a first and last name, an email address (which may be pre-populated with the email address which resulted in the prompt), and a relationship (e.g., from a drop-down menu). Once the fundraiser has selected or entered all desired recipients, he or she can submit the form (e.g., using a “share” button) to share the fundraiser's gift registry with the desired recipients. The gift registry module may allow the fundraiser to share his or her registry through one or more social networks, including third-party social networks, such as Facebook, Google+, and Twitter.

During the registration process, a progress indicator may be displayed, which indicates the registrant's relative progress or stage within the registration process. It should be appreciated that the progress indicator may be displayed at any position on the page (e.g., top right, top left, etc.) and at the same position for each page in the registration process.

The progress indicator may differentiate each stage of the registration process and provide links for the fundraiser to return to a previous stage of the process (or, in some embodiments, to jump to a future stage of the process). In an embodiment, the progress indicator comprises a horizontal bar comprising all of the stages of the process differentiated from each other (e.g., via lines, colors, spacing, etc.). Stages which have been completed may be displayed in one color (e.g., green), whereas stages which have not been completed can be displayed in a different color (e.g., gray, red, etc.). In an embodiment, the progress indicator comprises an image for three stages: (1) create account; (2) add to gift registry; and (3) create community. The registering fundraiser can click on any of these images to return (or jump) to the corresponding stage. In an embodiment, a visual cue is provided to the user after each stage is completed.

Each user interface for each stage can comprise instructions for completing that stage, including any requirements that must be met before the stage is complete and/or before the registrant can move to the next stage.

Once the registration process is complete, an indication can be provided. For example, a completion window can “fly in” to the registration window to let the fundraiser know that they have completed the registration process.

If there are any missing elements from any stage of the registration process, the completion window or another window may provide an indication and/or specify which elements are missing. For example, if a minimum number of community members (e.g., donors) is required and has not been met, then this may be indicated. Or if a minimum number of products for the fundraiser's registry is required and has not been met, then this may be indicated.

Once the registration process has been completed, including any missing or required elements, if the fundraiser logs out, he or she can return to the homepage of the website with which the fundraiser has registered or to a profile or registry page associated with the fundraiser. If the registration process is not complete and the fundraiser chooses to logout or otherwise exit the process, the system may save the registration information and provide the fundraiser with an option to complete registration at a later time.

When registration has been completed and/or when a registry has been completed, a confirmation email may be sent to the fundraiser associated with the registration or registry. The confirmation email may include a congratulatory message, product images for all added products, a link to a login page, and/or a link to the fundraising store with which the fundraiser registered or created the registry. An email may also be sent each time the registry is shared by the fundraiser.

In a section of the one or more of the transactional emails or in a separate—and optionally periodic—email, products which have not already been added to a fundraiser's registry may be recommended to the fundraiser based on products that the fundraiser has added to his or her registry. The recommended products may be associated with an “add to registry” button which, when activated, authenticates the fundraiser (e.g., using a username and password associated with the fundraiser and input during the registration process) and adds the product to the fundraiser's registry. Each of the emails sent by the system may comprise branding (e.g., logo) associated with the website with which the user is registered.

It should be noted that the registry or product catalogue can include products from partners or other vendors, such as retail chains that sell back to school gear or companies that sell school uniforms, etc. These products may be made available through separate catalogue available on the online store or through links to the partner or retailer. Thus, e.g., a student gets everything they need whether it is in the online store or offered through a third party.

Donor Purchase Process

From a donor's perspective, the donor may receive the URL of the registry from the fundraiser (e.g., via email or social network). The donor can click the URL to retrieve the registry user interface. The registry user interface will display the products or other items in the registry. The products can be listed in paginated form, if necessary. The number of items per page can be a user, administrative, or system setting, and can be different depending on the view or context (e.g., being viewed by a fundraiser associated with the registry, by a donor, during the registration process, after the registration process, etc.). The items may be displayed in a grid layout or other configuration. In an embodiment, the user interface may also comprise a set of products (e.g., five or some other number of products) that fall into the same types of products that have already been added to the gift registry. Additionally or alternatively, this set of products can be displayed when the fundraiser views his or her own registry. In an embodiment, the user interface also comprises information regarding the fundraiser associated with the registry. The user interface may also comprise a list of all fundraisers or other fundraisers with which the donor is associated.

For each item in the registry, the user interface may display an image of the product, a title, name, or description of the product with a link to a detailed description, a category of the product with a link to a page comprising all products in the same category, size desired, a desire level for the product set by the fundraiser associated with the registry, quantity desired, and the like. A zoom function may also be provided to allow a user to zoom in on a particular product's description or image. Each product may also comprise an action button which enables the donor to add the product to his or her shopping cart.

The donor may select one or more products from the product list to purchase. In some embodiments, a button or other input may be provided which allows the donor to select and/or purchase all products in the registry. When a donor selects a product, it is added to the donor's shopping cart. Once at least one item is added to the cart, the donor may be prompted or a button may be provided which enables the donor to checkout. It should be appreciated that the donor may be purchasing items for himself or herself or for the fundraiser.

If the donor chooses to ship the purchased item to the fundraiser, the address may be hidden to preserve the fundraiser's privacy or security. Otherwise, the donor may input a shipping address or use a default address which may have been provided during a registration process. If the donor purchases multiple items (including different items or more than one quantity of a single item), the donor may specify different shipping addresses for each of the items.

Once the purchase has been consummated, a confirmation email can be sent to the donor's email address. The confirmation email may comprise details regarding the order, including the shipping address(es) (if not hidden), and a brand (e.g., logo) associated with the fundraising organization.

It should be understood that the same process can apply to a user who simply wishes to purchase a product from the product pages for himself or herself or as gift, rather than from a registry of a fundraiser. The process is similar except that the user purchases products directly from the organization's store, rather than from a registry. In this case, the user is simply a donor to the organization or community, and may not be affiliated with any particular fundraiser. Accordingly, the shipping address should default to the donor's address, rather than a fundraiser's address.

A donor may or may not be required to register in order to view a registry, make a donation or purchase, and/or access other portions of the system or an organization's website. Incentives (e.g., access to registration-only resources, points, stored payment or other information, etc.) may be provided to encourage donors to register with the system. Registration can be beneficial to the organization, for example, by allowing targeted email and marketing campaigns.

Fundraiser Record

For each fundraiser (e.g., student) registered with the system, a fundraiser record may be stored in one or more databases. The fundraiser record may comprise a fundraiser identifier, a fundraiser name (e.g., first, middle, and last name), and an email address associated with the fundraiser. The fundraiser may also comprise gender and other descriptive information concerning the fundraiser. The fundraiser record may also comprise or be associated with a fundraiser registry identifier which corresponds to and is associated with the fundraiser's registry information.

Donor Record

For each donor registered with the system, a donor record may be stored in one or more databases. The donor record may comprise a donor identifier, a donor name (e.g., first, middle, and last name), an email address associated with the donor, and/or other donor-related information. The donor record may also comprise or be associated with one or more student identifiers and a relationship description (e.g., parent, grandparent, sibling, friend, etc.) for each associated student identifier. In addition, each donor record may comprise or be associated with a donor-since date (i.e., the data that the donor first registered with the system), a donor type, an activity status, and the like.

Administration Module

The system may comprise an administration module which facilitates administration of the system. The administration module may permit an administrator of the system to manage customers. Customers may fall into one of a number of groups. In the case that the fundraising is associated with a school, the customers may be categorized as general, student, faculty, and donor. The type of a customer can be changed from general to donor when the customer becomes part of a student's gift registry or has purchased from a student's gift registry. For customers categorized as students/fundraisers, the number of donors associated with the customer can be displayed next to their category type.

The customer records may be displayed in a list format, paginated list form, or other configuration. If an administrator clicks on a customer record, a customer view user interface may be displayed comprising customer information. The customer information may comprise personal information (e.g., customer name, etc.), community information (e.g., the community or communities to which the customer belongs), and gift registry information. The gift registry information may comprise the products in the registry, including the dates added (optionally with a range selector), dates purchased, product name with link to product details, name of purchaser with link to purchaser's customer record, gift event occasion, and/or password.

The administration module may also permit an administrator of the system to manage gift registries. A user interface may be provided which lists each user associated with at least one gift registry. Clicking on a user may retrieve and display information from the customer and/or registry record for the user in a separate user interface or frame. The displayed information may comprise an identifier associated with the registry and/or customer, a date range, event date, occasion, a status of the registry and/or customer (e.g., active or inactive), the customer's name (e.g., first, middle, and/or last name, and optionally with a link to the customer record), email address of the customer, a co-registrant's name with a link to the co-registrant's customer record (if any), total number of items in the registry, total number of items purchased, total dollar amount of items remaining, total dollar amount of items purchased, date of last user activity, and/or names of donors associated with the customer.

The administration module may also permit an administrator of the system to view each gift registry and its status (e.g., active or inactive), and to change the status of each gift registry. Inputs may also be provided to enable the administrator to set the minimum and/or maximum number of items permitted in all gift registries and/or each individual gift registry. The administration module may also indicate whether each gift registry has donors or does not have donors and/or how many donors each gift registry has.

The administration module may also provide the ability to export fields for an email campaign or other campaign, for example, in a comma-delimited (CSV) and/or Extensible Markup Language (XML) format. The module may export, for each fundraiser-donor pair, a name of the organization (e.g., school name), website identifier, ticker, donor identifier, donor first name, donor last name, donor email address, fundraiser identifier, fundraiser last name, fundraiser first name, fundraiser email address, registry identifier (e.g., URL), relationship between donor and fundraiser, graduation year of the fundraiser (if applicable), number of items in fundraiser's gift registry, fundraiser's birth date, and/or gender of the fundraiser. A person having skill in the art should understand that additional or fewer fields may also be exported, and that the administrator may be provided the option to select which fields to export from a master list of available fields.

The administration module may also permit an administrator of the system to manage donors, for example, by providing a list of donors in the system. The module may provide a list of fundraisers (e.g., students) with whom each donor is affiliated, the date on which the donor was first invited and the name of the fundraiser who first invited the donor. The list of fundraisers may comprise the fundraisers name, email address, the total number of orders made for the fundraiser by the donor, the total dollar amount purchased for the student by the donor, name of donor, date the order(s) were purchased, the date that the donor was added to the community, and/or the total number of orders with a link to an orders section.

The administration module may also permit an administrator to select, edit, and otherwise manage templates for transactional emails, such as registration confirmation emails and purchase confirmation emails. The administrator may specify a brand, such as a logo, to be included in the various emails, as well as subjects, messages, and other contents of the emails.

Order Module

In an embodiment, all product orders are for products of a base catalog, which is the same across all stores (although specific stores may exclude products for the storefront catalog). Each order can specify the specific transformations/modifications that are specific to the storefront from which the product was ordered and which should be applied to the base product to achieve the ordered product. Thus, in an embodiment, each order record includes or is associated with a field which comprises an identifier of the storefront through which the order was placed.

Orders which are created through the various storefronts can be exported via an order export module or other module. The orders can be exported in any of a variety of formats, including CSV or XML formats. The exported order information can include the configuration information for the products of each order, and/or a link to production quality artwork. Exported information can be transmitted to a vendor for fulfillment. In an embodiment, each order is approved prior to transmission.

Donor Management

In an embodiment, a donor management module is provided for donor management and reporting. The donor management module may be accessible to fundraisers (e.g., students) and/or administrators (e.g., as part of the administration module). The donor management module may provide a user interface for adding, editing, or deleting donors from the system. The user interface may comprise, the donor type, the donor identifier, the donor's name, the donor's email address. The user interface may also comprise the fundraiser identifier(s) associated with the donor, along with the associated fundraisers' names, email addresses, relationships to the donor, etc. The user interface may also provide a link to the each associated fundraiser's registry, display the number of items in the fundraiser's registry, and provide a link to the website with which the fundraiser is associated. In embodiments, where the organization is a school, the user interface can display the student's graduation data or year. The user interface may also comprise the donor-since date, and whether or not the donor is active. One or more of these fields may be editable.

The user interface may comprise a list of donors, and may allow a user to perform actions for each donor (e.g., edit or delete). The user interface may also comprise a count of the total number of donor records, and may provide the list in a paginated format in which only a certain number of records are displayed per page. The user interface may further comprise a button to allow the addition of donors.

The donor management module may allow a user to export the donor records, for example, in comma-delimited (CSV) format. It may allow a user to set and reset filters and other search inputs. It may also allow a user to check multiple donor records and perform a group action on the set of checked donor records. For example, the user may be provided the option to select or unselect all of the donor records, select or unselect all visible ones of the donor records. The user interface may display the number of selected records.

The donor management module may also provide a user interface for editing donor records. For example, each donor record in the above described list may comprise a link to an edit page for editing the fields associated with individual donor records. The donor edit page may comprise personal information, customer status information, and/or donor account information.

For example, the personal information may comprise the date, if any, that the donor last logged in, or otherwise state that the donor has never logged in. The information may also comprise the date on which the donor was created, the name of the website(s) or organization(s) (e.g., school) with which the donor is registered. The fundraiser (e.g., student) association(s) of the donor, including names, relationships, and front-end and/or back-end links to the fundraisers' registries.

The customer status information may comprise whether the donor is active or inactive. If the donor is active, the information may further comprise whether the donor is registered or non-registered, a link to the donor's customer record and/or orders, and/or the number of guest checkouts.

The donor account information may comprise the websites with which the donor is associated, the website with which the donor originally registered and from which the donor record was initially created, the first, middle, and last name of the donor, an email address associated with the donor, and/or the names, emails, and relationships of fundraisers associated with the donor.

Most-Popular Module

The system may comprise a most-popular module which enables users to visually see the most popular items for a particular fundraising organization (e.g., school), for example, in order of popularity. The most popular items may comprise a set of items having the most purchases. However, the set of items which are displayed by the best-selling module may be modifiable by an administrator, for example, using the administration module. For example, administrative controls can be provided to allow an administrator to remove products from and add products to the best-selling list. The module can display a predetermined number of the best-selling products unless excluded by an administrator.

In an embodiment, the most-popular module maintains a queue of a number of items (e.g., 20), even when no activity has occurred, so that there is always a list of most popular items displayed. The module may display the list of the most popular items on both the organization's home page, as well as the organization's store page. Each item may include a product image (e.g., thumbnail image) and product name, either or both of which may include a link to a detailed product page. Each item may also include a category name with a link to a page comprising all of the items in that category. The module may also provide functionality which allows a user to add one or more of the most popular items to his or her cart or registry, including a selection of available options (e.g., size).

The administrative controls may also permit an administrator to disable and enable display of the most popular items. It may also allow the administrator to specify the minimum dollar amount of items (i.e., the minimum product value allowed to be visible in the most popular section) and number of items (e.g., default=5) that should be displayed in the most popular items section of the home page and/or store page for an organization. The number of most popular items to be displayed may depend on the orientation of the most popular section. For example, if the section is to be displayed horizontally on the home page and vertically on the store page, the horizontal display may have more or fewer items than the vertical display, as determined, for example, by an administrative setting. As discussed above, an administrator may also disallow products from the most popular section, as well as select specific products to display in this section. The administrator may select date ranges for these product override selections, or if no date range is selected, the override selections may remain indefinitely.

In an example embodiment, on the organization's home page, the most popular section can be clearly labeled to indicate what it represents (e.g., “Most Popular”) and is displayed as a vertical section or frame along the left or right side of the page. The section displays a number of the most popular items as determined by administrative settings. Each item can comprise a thumbnail image of the product, the title or brief description of the product with a link to a detailed product description, and the category of the product with a link to a list or grid of products in the same product category.

In a further embodiment, the organization's store page also comprises a most popular section which is clearly labeled and displayed as a horizontal or vertical section. Each item in the section comprises a thumbnail image of the product, the title or brief description of the product with a link to a detailed product description, price, size selection (e.g., drop-down input), an option to add the item to a cart or registry, and an option to compare the item to other items.

Community Display Module

In an embodiment, the system comprises a community display module. A fundraiser can receive and interact with a user interface provided by the community display module to view and manage the fundraiser's community. One page, section, division, or frame of the user interface can list community members (e.g., donors) associated with the fundraiser. The community members may be listed in an order based on certain criteria. For example, a number of donors who have been the most active in the community can be displayed with the most active donor first. The list may comprise all the donors in order of activity, with pagination if desired or needed according to either a user setting, administrative setting, or system setting with a default (e.g., if the list comprises more than 5 donors). The criteria for which donors are the most active can be based on the number of items purchased or the total dollar amount of items purchased. The criteria may also comprise or take into account the number of visits to or interactions with the fundraiser's registry. For instance, in one embodiment, the list comprises all donors in high-to-low order of total dollar amount of items purchased, and then comprises all donors who have not purchased any items in high-to-low order of visits to the fundraiser's registry. It should be understood that multiple, different lists based on different criteria, or no criteria at all, can be provided on the same pages, or on different pages, sections, divisions, or frames of the user interface.

The community display module may also provide a user interface for adding new members to the community. This user interface may be provided on the same page as the list(s) of community members, optionally, in a different section, division, frame, or widget, or on a different page. In an embodiment, if the fundraiser has less than a set number of community members (e.g., 5, which may be a user setting, administrative setting, or system setting)), any newly added members will be displayed after the last community member. If the fundraiser has more than the set number of community members, the newly added member may be displayed temporarily below a list of previously added members currently being displayed (e.g., as part of the list described above). The newly added member(s) may be differentiated by a section title, such as “Newly Added.” This section may remain during the duration of the fundraiser's current session.

Direct Sale Product Configurator

In an embodiment, or as a separate system, a direct sale product configurator is provided. The configurator is intended to ease the labor of direct sales team members as they present and design customized products for potential or existing customers/organizations of the multi-store system described above. The configurator may be executed on a desktop, mobile device, such as a smart phone or tablet PC (e.g., iPad®), or any other computing device. Alternatively, the configurator may be executed on a web server which is accessible by and compatible with a computing device, such as a desktop or mobile device. A sales team member may log in to the computing device, application, and/or a website of the web server.

The configurator allows direct sales team members, with minimal training and little to no technical knowledge, to select from pre-loaded art and present a preview of an entire catalog of custom products to the customer organization. The catalog of products can be customized to the particular customer in a similar manner, as described above, i.e., by using an art style object and image package archive to transform a base image package into a customized product catalog. The art style object, image package archive, and/or customized product catalog can be saved for future showings.

The customized product catalog can be shared. For instance, if the direct sales team member selects to share the catalog, it can be automatically saved and an email with a link to the newly created product catalog can be sent to the customer for future purchases. It should be understood that the “customer” in this case may refer either to an organization which utilizes the system or a donor.

In an embodiment, the configurator can be provided to the customer, in addition to direct sales teams, such that the customer can modify previously created products. In an embodiment, customers can only modify products that were previously created and shared with the customer by a direct sales team member. Alternatively, the customer may be able to create new products from a base product catalog.

In an embodiment, the configurator comprises a front-end user interface, one or more hardware interfaces, and on or more communication interfaces. The front-end user interface allows direct sales team members to navigate intuitively through the configurator, creating custom designed products. The front-end user interface can include a login page for authentication and options to select saved products and create new products.

In an embodiment, a user of the configurator can create an organization (e.g., school) and upload art associated with the organization. The uploaded art may comprise a ZIP file or folder. Once uploaded the file can be unzipped and displayed (e.g., in a paginated user interface). In an embodiment, the file is automatically unzipped upon upload and all the contents displayed. The art may be displayed as transparent PNG files with specific dimensions (e.g., 1,000 pixels×1,000 pixels). Pagination may occur if the number of art files exceeds a maximum number of art files per page, which may be a user setting, administrative setting, or system setting. The configurator can determine properties of the uploaded art, including art style, name, location, size, aspect ratio, and/or allowable products, including allowable product colors. Alternatively or additionally, the user may be prompted to enter art properties, e.g., from an art style drop-down.

An embodiment of a method of using the direct sale product configurator will now be described. A user may access the configurator application, for example, either directly on a user's device, or via a web page retrieved from a web server and displayed in a browser application of a user's device. Initially, the configurator may provide a user interface for authenticating the user. The user may be required to input and submit a username and password or other authentication information. Alternatively, no authentication may be required.

Following authentication (for embodiments which require it), the user is provided user interfaces for selecting products (e.g., by selecting a hyperlink or other reference in the form of an icon, image, or text) and art options (e.g., by selecting a hyperlink or other reference in the form of an icon, image, or text).

A user may be permitted to browse all available art options. The user may also be provided with one or more inputs (e.g., radio buttons, checkboxes, text boxes, etc.) for filtering which art options are displayed on a user interface. For example, the user may be able to filter the art options based on art style, name, color, art category, mascot, etc. If a user selects an art option, a list of products for which the art option is available may then be displayed. The user can then select one or more of the products (e.g., using checkboxes associated with the products) for which the selected art option is available.

It should be understood that these steps can be performed in a different order. For example, the user may first browse and/or filter all available product. The products may be initially displayed using a default color. Available filter options may include, without limitation, category (e.g., apparel, gender, age, sports, accessories, etc.), name, color, and the like. The user may then select one or more products and be provided with a list of art options that are available for the selected product(s). As before, the user may be able to filter the art options, for example, based on art style, name, color, art category, mascot, etc. One or more art options may be selected (e.g., using checkboxes or other inputs associated with the art options) for the selected product.

In either case, the user may select color options and/or other options for the selected products and/or art options. The user may save these customized products with their available art options. When a new customized product is saved, it may be associated with a product identifier, a creation date and/or time, a name (which may be provided by the user or generated automatically, for example, based on the product and the art option), comments or a description provided by the user, and/or any other fields which may be relevant to the product and/or art option. In addition, an image of the customized product (i.e., the product with the selected art option, color options, and any other options) can be added to a lightbox, i.e., set of one or more images of customized product(s) created during the configuration process. If the customized product is the first one created or saved during the configuration process, a new lightbox can be created for it and any future configured products. Once a customized product is created and/or saved, the user may be provided with the option to create another customized product and/or send the product image or lightbox to a recipient (e.g., via email).

In an embodiment, a user may select and order product(s) from a lightbox or other list of customized products created during a configuration process. A user interface may provide the user with the ability to select products and add or update a quantity of the selected products. In addition, prices, including a total price, can be displayed for the selected products. The user can then save and/or complete an order. When the order is completed, a notification (e.g., email) can be sent to a fulfillment provider in charge of fulfilling the order. A confirmation (e.g., email) can also be sent to the user or purchaser.

Product Pages

An embodiment of the product list page will now be described. It should be understood that the description of the product list page can apply to both the page presented for an organization's online store, as well as for the configurator.

The product list page can identify newly added products. It can also highlight products with special features, such as limited time offers, timed offers, blowout prices, campaigns, etc. The page can also show star ratings for items that have been rated. In an embodiment, all ratings and/or reviews may be pre-approved prior to publication in the store.

The product list page can comprise a link to a product description page for each product displayed on the product list page. The product description page can be considered the “brick and mortar” of an ecommerce site. A traditional brick and mortar store allows customers to interact with the products, for example, by touching them, viewing them at various angles, weighing them, hearing them, etc. An ecommerce site, unlike a physical store, should compensate for this lack of physical interactivity by providing the most visual and/or audio information about each product that it can.

The product description page can comprise information on multiple tabs. In an embodiment, product images can be displayed for each product. There may be multiple images, for example, at multiple angles, for each product. Both back and front images can be displayed for products that have designs on both the front and the back, as well as for those products which may not have designs on both the front and the back.

Furthermore, if a product has unique qualities, additional images exhibiting the unique qualities can be displayed. For example, images can be provided for pattern materials (e.g., plaid), textured materials, unique stitching (e.g., reverse stitching), art methods (e.g., etching, stitching), tag-less products (e.g., showing a image that demonstrates that the product is tag-less), art work (e.g., the art work can be displayed apart from the product, as well as on the product), and the product as worn on a person or mannequin. Zoom functionality may also be provided for one or more of the images. Thumbnail navigation may be provided for the images as well.

In an embodiment, each product and/or product description page can have a title. The title may comprise a name of the organization (e.g., school name), mascot (if applicable), gender (if applicable), color, and/or type of product. For example, if the name of the organization is “Palisades Charter High School,” the mascot is a dolphin, the primary color of the product is light blue, and the type of product is an ultra-soft t-shirt, the title can be “Palisades Charter High School Men's Light Blue Ultra-Soft T-Shirt”.

In an embodiment, each product and/or product description page also includes a description. The description may be brief or contain as much information about the product as possible. The description can be dynamically populated with an organization's name and other parameters (e.g., mascot, etc.). For example, the description can be stored as a template with tags or other placeholders for inserting dynamically acquired information on the fly. The description can contain product details (e.g., in bullet point format) such as fabric type, product cut, weight, and the like. The description may also comprise production time and/or shipping information.

In an embodiment, each product and/or product description page also includes a color chart. The color chart can comprise swatches of all the colors in which the product is available. If a user clicks on one of the swatches, a displayed image of the product in one color can be replaced by a displayed image of the product in the color of the selected swatch. A size chart can also be displayed.

In an embodiment, each product and/or product description page can also include a rating. The rating may include an overall product rating, based on individual customer ratings. To prevent bots from posting ratings or reviews, rating forms can use anti-bot techniques, such as CAPTCHA. For example, before a customer can submit a rating or review, the customer may be required to identify distorted characters within a displayed image. In addition, in an embodiment, each customer rating and/or review may be subjected to review prior to it being published for the product.

In an embodiment, each product description page can permit a customer to contact an administrator or other operator of the site if there is a question or problem with a product. For example, each product description page may contain contact information, a form, or a link to a form or online chat application, which enables the user to contact a customer service representative.

In an embodiment, the product list page can include filters or sort fields. For example, users may be permitted to filter or sort products on the product list page by category, price, brands, mascot-decorated items, color, and the like. In the case of color, the filter can be provided as color swatches, rather than the name of the color.

Customer Experience

Additional features can be provided to enhance the user experience of the system. For instance, the system may allow a user to use a single sign-on. For example, the system may provide a user with the ability to sign in to the system using credentials associated with a social networking site (e.g. Facebook®). For example, Facebook Connect provides an application programming interface (API) by which a third-party site, such as the disclosed system, can authenticate and identify a user through the user's registration with Facebook. For example, the user can sign into Facebook and authorize Facebook to provide registration information to the third-party site, which may include the user's name, contact information, and other personal information, as well as provide the site with access to the user's friends, wall, and the like.

In an embodiment, one or more or all of the web pages served by the system for an organization can provide a link or form for the viewing user to provide feedback for a product or for the website in general.

In an embodiment, the system comprises an online chat module (e.g., on the product list page, product description pages, shopping cart page, checkout page, etc.) The online chat module allows a user to chat with a customer service representative (e.g., through a text box, or microphone and speaker). The transcripts of all online chats may be stored for future reference and internal quality assurance enhancements.

The system may also comprise a general contact page, comprising general contact information for the organization or an operator of the site (e.g., phone number, fax number, email, address, etc.).

In an embodiment, trusting seals and security icons can be utilized to establish trust with users. In addition, reward points (e.g., for purchases in proportion to dollar amounts of the purchases) may be used to build the loyalty of customers. In addition, automated meta tags and meta descriptions can be used for search engine optimization (SEO), to enhance visibility of the sites.

User Interfaces

The user interfaces for the disclosed systems can utilize any one or a combination of conventional technologies, such as HTML, HTML 5, CSS, CSS3, JavaScript, PHP, and XML. Support can be provided for numerous browsers, including Safari, Firefox, Opera, Chrome, Internet Explorer, and Firefox, and be compatible with numerous platforms (e.g., Apple iPad, Android devices, etc.) and operating systems (e.g., MAC OS, Microsoft Windows, etc.). The system or user interfaces of the system may be programmed such that they are able to detect the browser being used and adjust the user interfaces accordingly.

In an embodiment, drop-down and/or layered navigation can be used. For example a drop-down menu can be provided listing each category. When a category is hovered or moused over, an expanded menu or area can be displayed. The expanded area can comprise a thumbnail presentation of products in the category with links (e.g. “more”) for more details. Layered navigation can be used to layer or cascade sub-menus with respect to their parent menus.

Additional navigational tools can be used, such as a site map page and/or breadcrumbs (e.g., “home->store->product list”) which allows users to view and retrieve parent pages for hierarchically arranged pages.

Search functionality can be provided for each organization's site. A search field may be displayed on most catalog (store) pages. Searches results may comprise images and links directly to products. Users may also be given an option to perform advanced searches, which may comprise a form on a dedicated web page.

Modules

In an embodiment, a variety of different user interfaces and modules can be provided. The user interfaces may comprise entire web pages or sections or portions of web pages. Each user interface may correspond to one or more separate and/or shared software modules or widgets. By way of illustration only, the user interfaces and/or modules may comprise a most popular module, a home page search module, a mini-logon module, a registration module, a gift registry module, a student gift registry widget, an add to cart module, an add size from product list module, a recent activity module, a donor community widget, a student confidentiality module, a transaction order confirmation module, a custom account dashboard, a disable store module, a store maintenance page, manage products module, order status module, delete order module, donor email export module, gift registry export module, order notification module, order view module, transaction email module, and the like.

The most popular module may display the most popular products (e.g., based on number of views). It can rotate positions of the products on a page refresh. In addition, administrative controls can allow an administrator to set the number of products to be seen on the front end, deselect products which the administrator does not desire to be seen, select special override items to be seen first, and/or enable and disable the module.

The home page search module may dynamically populate searches based on newly added stores, or allow an administrator to manually populate searches. The module can provide predicted search terms in a drop down as a user types in a term, for example, based on pattern matching with terms in stored search histories.

The mini-logon module can provide a “create account” and “login” toggle on one or more web pages or other user interfaces.

The registration and gift registration module or modules can allow fundraisers (e.g., students) to create accounts, add or delete products to or from a gift registry, and/or add donors to the community.

The gift registry widget can allow fundraisers (e.g., students) to see what products have been added to the store, and what products are currently in their gift registries. It can allow a fundraiser to add products, edit desired quantities of products, and/or delete products from his or her registry.

The add to cart module can display a user interface within a web page, and provide users with the ability to add products to their carts. Newly added products can appear in a cart display within a web page (e.g., on a navigation bar). Newly added items can appear with the last-added product on top. A maximum number of items to be displayed (e.g., 5) may be predetermined. The user interface may provide an input which the user can interact with to view all products in the cart (e.g., by linking to a detailed cart display page).

The add size from product list page module can allow users to add sizes directly on a product list page and/or an organization store home page without having to retrieve a product description page.

The recent activity module can be displayed on a portion (e.g., in a section) of an organization home page and/or all product catalog pages. The module can display best-selling products based on purchase histories. A predetermined number (e.g., 20) of products can be displayed or queued for display. Thus, even if no activity has occurred, products will still show in this section. Alternatively or additionally, the recent activity module can display products recently added to a user's gift registry or products recently viewed or purchased (e.g., for a donor).

Alternatively or additionally, the recent activity module can display information about individual recent purchases. For example, on a portion of the organization home page, catalog pages, and/or other pages, the module may display messages about recent purchases (e.g., “{Donor} purchased a {Product Name}”). For example, a message may comprise text stating “Amanda purchased a Canvas Sport Bag.” The message may also comprise a link to the product detail page for the Canvas Sport Bag (e.g., the text “Canvas Sport Bag” may comprise a hyperlink).

The donor community widget module can provide donors with the ability to see all registries with which they are associated. These names of the owners of the gift registries can be displayed, and the registries displayed in an accordion style. For instance, if a user clicks on the name or other reference associated with a gift registry, an interface section can appear to slide out to reveal the associated gift registry. A “view all” button can be associated with the gift registry to allow a user to retrieve a web page or other user interface associated with the full registry. Thumbnail images, titles, add to cart inputs, quantity inputs, etc., can also be displayed for each registry. An input may be provided to allow a donor to add all products in a registry to his or her cart.

The student confidentiality module ensures that all fundraiser address and personal information are hidden from view by others (e.g., during the order process, on transactional emails, etc.). This ensures privacy, which can be important in embodiments where the fundraisers are students who may be minors.

The custom account dashboard module allows an administrator to control messages, image displays, and the like.

The disable store and maintenance page can allow an administrator to disable an organization's website/storefront. In its place, the system can display a maintenance page, which may be editable by the administrator. If a website/storefront is disabled, the organization can be removed from the home page search.

The order status module may allow an administrator to manage order status settings, such as editing the supported statuses for user account information, transactional emails, and/or internal views.

The manage products module may allow administrators to manage products and manage product views.

The delete order module may allow users and/or administrators to delete or otherwise edit or manage orders that have been placed.

The donor email export module may allow users (e.g., fundraiser and/or administrators) to view donors, delete donors, find donors using filters or search terms (e.g., email address), export donors for email campaigns, and/or delete orphan donors (i.e., donors which are not associated with any fundraisers or registries, e.g., because the fundraiser or registry was deleted).

Sales Features

The system may provide features to increase sales for fundraising organizations, such as up-selling and cross-selling (e.g., on registry pages, product pages, shopping cart page, checkout page, etc.), tiered pricing on special products, gift certificates, product feeds (e.g., Google® Merchant Center), A/B testing on product images, and/or A/B testing on free shipping coupons.

Ordering

A user may browse and interact with an organization's store to add products to an electronic shopping cart associated with the user. The user may then purchase the product(s) added to his or her cart. If the user chooses to view his or her cart, a user interface may be provided to display the products in the cart. Other products can be displayed on the user interface to enable up-selling. These other up-sell products may be chosen by the system based on the products in the user's cart and/or past purchases made by the user and/or other users (e.g., same or similar product category or type, style, size, color, etc.). In an embodiment, the up-sell products are distinguished from the products in the user's cart (e.g., displayed in a separate section of the user interface).

Once a user proceeds to the checkout process, the user may be prompted with fulfillment information, such as delivery information, available payment methods, and available shipping methods and details. For example, different payment methods, such as credit or debit card, Paypal™, Google Wallet™, etc., can be offered to the user. International shipping options may be provided for those countries to which the organization allows shipping. Tariff or customs fees may be handled by one or more third parties.

When an order has been completed, the system may send an email confirmation. The email confirmation may include customer billing information and shipping information (or just shipping information if the same as the billing information). If the order is by a donor as a gift for a fundraiser (e.g., student), the email confirmation may also include a gift purchase message (e.g., “Purchased from Gift Registry for {Name of Recipient}”). Furthermore, if the order is by a donor for a fundraiser, in an embodiment, the shipping address is only displayed in the confirmation if the address is identical to the billing address. Otherwise, the confirmation indicates that the shipping address is the fundraiser's address (without displaying the address). The email confirmation may also include a link to check shipping status. For example, the link may take a customer to a form for checking order status without requiring login.

In an embodiment, the system provides order tracking. Customers may be permitted to track orders without being registered or logged in. For example, a customer may be able to search for an order status using an email address used in or associated with the order and an order number or last four digits of a credit card used for the order. In an alternative embodiment, only registered customers may be permitted to track orders.

A contact form can also be provided to check shipping status. The form may include first and last name fields, an order number field (if applicable), a phone number field, a customer email address field, and/or a comment field.

Before (e.g., while products are still in the user's cart), during, or after the ordering process (e.g., after payment has been submitted), the fundraising portion of the purchase can be provided to the customer. The fundraising portion is the amount (e.g., a percentage or dollar amount) of the purchase which is given to the organization. The remaining portion, if any, may be allocated to the operator of the system, third party suppliers, fundraisers, payment processors, and the like.

In addition, points can be provided to fundraisers (e.g., students) for items that were purchased from the fundraiser's registry. Additionally or alternatively, points can be provided to customers for items that they purchased from an organization's store or fundraisers' registries. These points can be maintained and displayed to purchasers and/or the fundraiser on one or more interfaces provided by the system (e.g., with product descriptions, with shopping carts, with orders, etc.). The points can be in proportion to the purchase price of the products or the fundraising portion of the purchase price. For example, one point may be awarded for each dollar or cent purchased or raised.

In an embodiment, customers can only earn buyer points if they register with the system or organization's website. Customers may also be given the opportunity to transfer their buyer points to fundraisers (e.g., students) with whom they are associated.

In addition, milestones for an organization or a fundraiser can be displayed in one or more user interfaces of the system. For example, a milestone may comprise a predetermined amount of funds raised (e.g., $1,000, $10,000, $100,000, etc.). Milestones may be related to a specific campaign, club, division, sub-organization, etc. Thus, an organization with multiple campaigns or sub-organizations may have multiple milestones. For instance, if the organization is a school, it may have a milestone for funds raised during an annual fundraising campaign for the school, a milestone for funds raised for the football or other sports program, a milestone for funds raised by the chess club, etc. In this case, the milestones may be displayed together or separately (e.g., on pages related to the campaign or sub-organization with which the milestone is associated).

Merchandise Returns

In an embodiment, the system allows customers to request for a Return Merchandise Authorization (RMA). For instance, a return request form may be provided. The return request form may comprise user interface with one or more input fields. The inputs fields may include, without limitation, first name, last name, an order number or other identifier of the merchandise, and/or a reason for the return. Return policies and restriction information can also be provided to customers on the return request form and/or at one or more points during the ordering process.

Advertising

In an embodiment, an operator of the system or an organization can specify or select advertisements (e.g., banner advertisements) to be placed on interfaces (e.g., web pages) of the system or organization. These advertisements can generate additional revenue for an operator and/or additional fundraising for an organization. In addition, the advertisements may be used to promote a particular fundraising campaign of an organization.

Analytics

In an embodiment, the system dynamically tracks user movements throughout an organization's website in order to collect and store data on user sessions. For example, the system may track how many times a product has been viewed, amount of time spent on a page, etc. This tracked data can be used to tailor a display of products based on a particular user's, group of users', or all users' browsing. In an embodiment, products can be recommended to users based on theirs and/or other users' browsing history.

Example Table Structures

Any of the data described herein can be stored in tables or other data structures, for example, in a database. In an embodiment, the database may be a MySQL database or other relational database.

By way of example only, a product table may associate products with one or more data fields, including, without limitation, a primary identifier, brand, style, sizes, colors, images, image metadata, material, Global Trade Item Number (GTIN) or other identification number, product care, value range, Stock Keeping Unit (SKU), decoration restrictions, decoration locations, light/dark indicator, default display color, possible vendors, proprietary color identifier, organization choices, view, angle, price, cost, etc.

By way of example only, an art option table may associate art options with one or more data fields, including, without limitation, a primary identifier, SKU, display name, Uniform Resource Locator (URL) or other file location, decoration optimization, minimum size, maximum size, designed-for sites, description, location restriction, color of blank at the decoration location (e.g., using a color table), organization, art category (e.g., for browsing).

By way of example only, a color option table may associate color options with one or more data fields, including, without limitation, a color identifier, color name, hexadecimal value, etc.

By way of example only, a location table may store product locations (e.g., for art options), including, without limitation, a location identifier, location name, x-y coordinates or distances, angle, scale, width adjustment, height adjustment, etc.

Teacher Gift Registry

Teachers have many needs and challenges in today's education environment including non-reimbursed expenses for classroom supplies and students who lack the supplies required for their classes. The teacher gift registry provides an online platform through which these supplies may be purchased and donated based on a classroom supply list and a student required supply list.

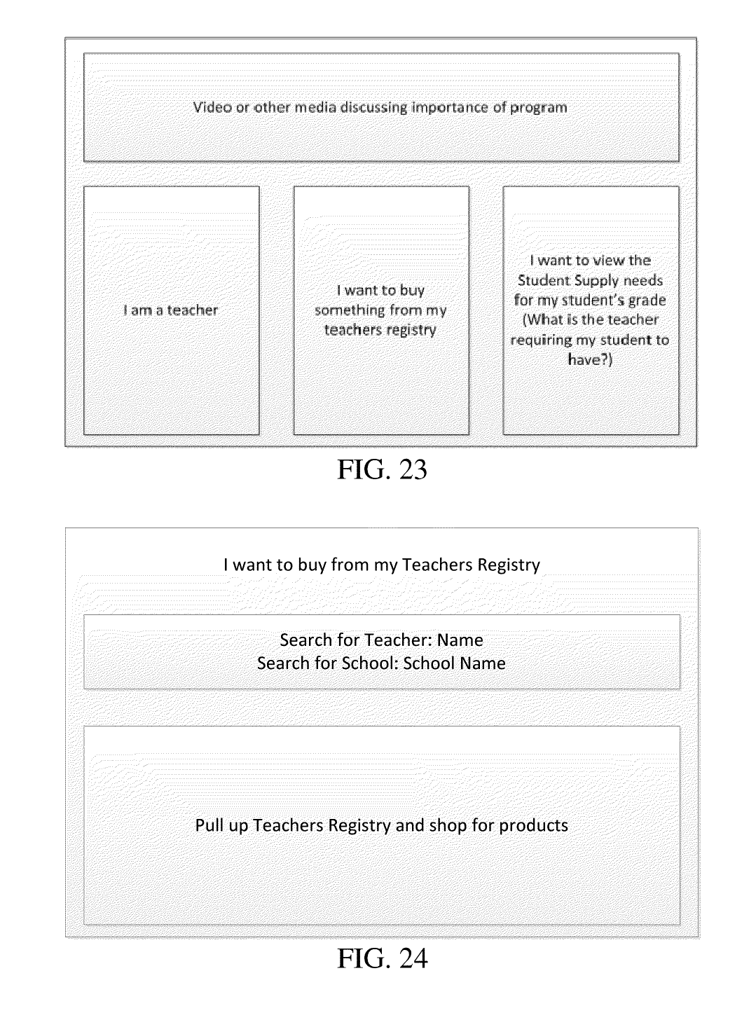

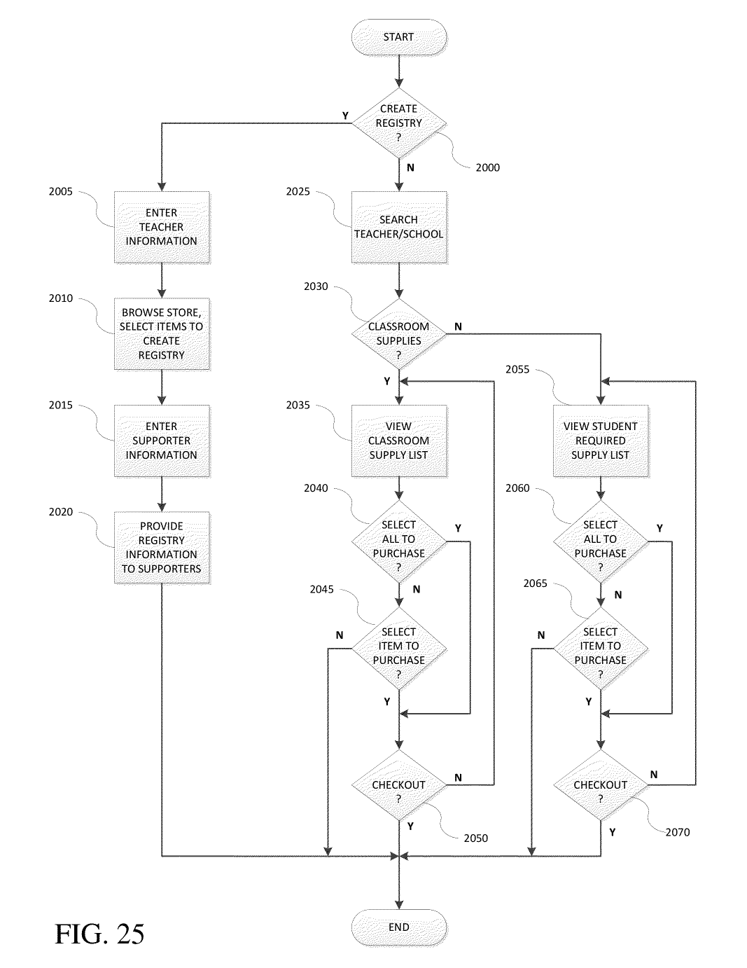

FIG. 23 illustrates a graphical user interface according to an example embodiment of the present inventive concept. The graphical user interface may be generated by a graphics module, for example, but not limited to, a processor comprising a graphics module. FIG. 25 illustrates a process of creating and using a teacher registry according to an example embodiment of the present inventive concept. The process may provide options for a teacher to create a registry and for supporters to access a created teacher registry (2000). The graphical user interface may also provide information relating to teacher registry program. A teacher may create a registry of needed school supplies by selecting from available products. The registry is connected to an online store that will carry products including products specific to classroom needs of teachers and students. Others, for example, parents or friends of students or the teacher can search for the teacher's name and view the items in the teacher's registry. The items may be purchased and delivered directly to the teacher.

A teacher registry may be initiated manually by a teacher through a registration module which presents a user interface that allows the teacher to provide information specific to the teacher, for example, but not limited to, name, school, grade taught, email address, shipping address, etc. (2005). One of ordinary skill in the art will appreciate that the user interface display may take various forms without departing from the scope of the present inventive concept. The registration module may be implemented by, for example, but not limited to, a processor programmed to perform functions of the registration module.

When a teacher registers, both a classroom supply list and/or a student required supply list may be automatically created. Through the registration module, the teacher may then browse the online store and add required classroom supplies and/or student supplies from the online store to the registry to build the classroom supply list and/or the student required supply list (2010). The classroom supply list informs supporters of supply needs for the classroom (e.g., wipes, paper towels, fall decorations, etc.) and allows those supporters to buy on behalf of the teacher and the classroom. The student supply list that provides a simple list of the items needed for the student to participate in the class for that school year. This is a quick, one-stop shop for a student's needs.

The teacher may add any quantity of a given product. As products are purchased, the displayed quantity may be decremented and when the quantity reaches zero, the product will be indicated as fulfilled. However, to permit a teacher to easily manage the registry, all products will remain visible to the teacher even if all quantities are bought. Some products, for example consumable products such as disinfecting wipes, which are needed on an ongoing basis can be set so as to never show as fulfilled. When a teacher makes a change to the classroom supply list or student supply list, a communication is automatically sent to all of the supporters.

Finally, the registration module may include a contact list creation module which provides the ability to add supporter names and contact information, for example, names and information of parents, previous students, school admin, friends and family, etc. Contact information for potential supporters may be imported, for example from a contact list, or manually added (2015). After a teacher registry is created, social media may be used the teacher or by a registry administrator to publish and/or share its existence online and in particular with potential supporters (2020).

The system may comprise a teacher registry module which provides a user interface to the teacher and supporters. The teacher registry module may be implemented by, for example, but not limited to, a processor programmed to perform functions of the teacher registry module. The user interface may display the products in the teacher's registry in a list, grid, matrix, or other configuration. For each product, the user interface may provide an image of the product, a name of the product, a link to more details, a size (if relevant), a quantity desired, and a quantity remaining. In the teacher's view, the user interface may also provide a delete button for each product. In an example embodiment, products may be removed from display or may be indicated as fulfilled in the teacher registry user interface if the quantity of products desired has been satisfied.

When the teacher's registry is shared, a supporter may receive the URL of the registry and may click the URL to retrieve the registry user interface. FIG. 24 illustrates a search page of a user interface according to an example embodiment of the present inventive concept. Through the user interface, a supporter may search for a specific teacher at a specific school and access the teacher's registry (2025). The registry user interface will display the products or other items in the registry, (2030) and may indicate a classroom supply list (2035) and/or a student required supply list (2055), as well as associated quantities of each item. One of ordinary skill in the art will appreciate that the user interface display may take various forms without departing from the scope of the present inventive concept.

A supporter may select one or more products from the product list to purchase. (2045, 2065) In an exemplary embodiment, a button or other input may be provided which allows the supporter to select and/or purchase all products in a classroom supply list and/or a student required supply list. (2040, 2060) When a supporter selects a product, it is added to a shopping cart and the supporter may be prompted or a button may be provided which enables the supporter to checkout (2050, 2070). The products may be shipped to an address provided by the teacher during creation of the registry.

Supporters may choose to have their names displayed in recognition of having purchased items on behalf of the teacher, and may have an option of posting the donation on social media sites. Also, a loyalty program may be implemented, for example to award points redeemable in the registry, to reward all participants.

An example of navigation flow of the online teacher gift registry may be Enter Site>Home Page>Teacher or Parent/student path>>Teacher Path>Sign Up>Build your classroom wish list and student supply list>Publish and Share>Parent/Student Path>Find your teacher>Buy your student supply list or buy something from teacher wish list>Share with others. The teacher registry may incorporate some, all, or none of the features of other above-described aspects of the present inventive concept.

### FIGURES

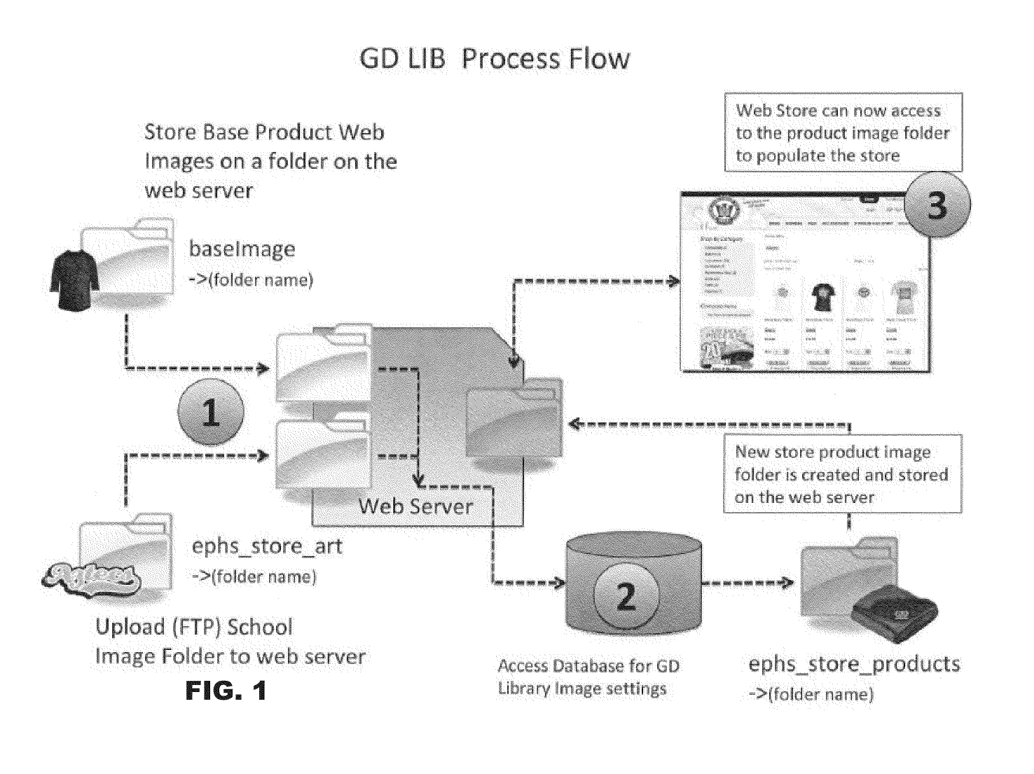

FIG. 1 illustrates a process flow for creating a custom image library for a store, according to an embodiment. Base product images are stored in a folder on a web server. In addition, art images are stored in a folder on the same or a different web server. The folders may be named according to a predetermined naming scheme. The base product images and art images may be stored in the same or different databases locally or remotely accessible by the web server. When a web store is created, custom product images can be created for the store and stored in a new folder on the web server. This folder may also be named according to the predetermined naming scheme. A web store can then access the folder of custom product images to populate the online storefront.

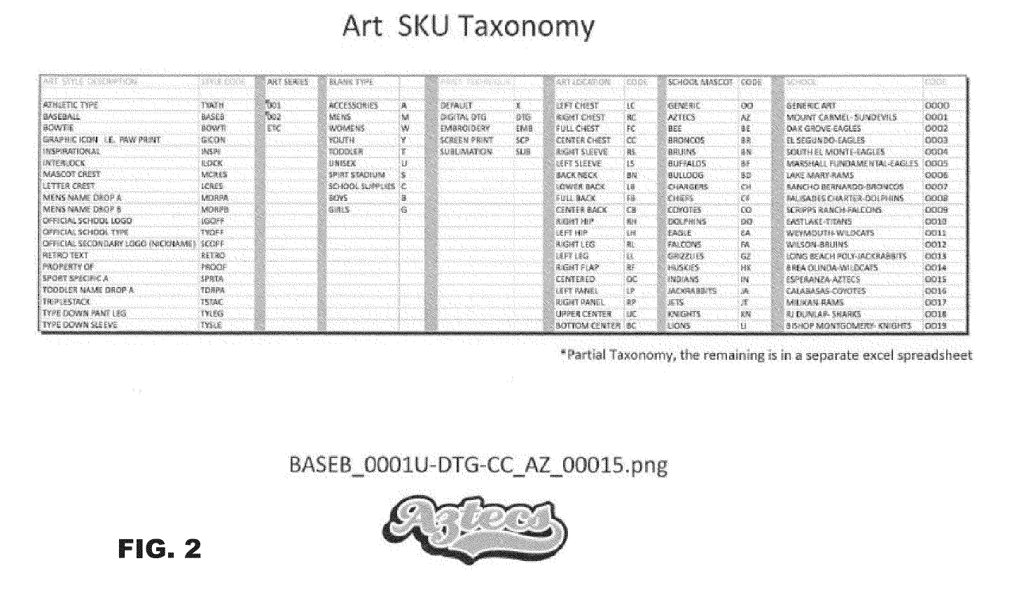

FIG. 2 illustrates an art SKU taxonomy, according to an embodiment. The taxonomy can associate art styles, art series, blank type, print techniques, art locations, brands/mascots, organizations, and the like with predetermined codes that can be used in a naming scheme for folders and files, for example, stored on a web server and accessed by storefronts. For example, a custom product image file can be named by appending the codes in a predetermined order according to the product that the image file represents.

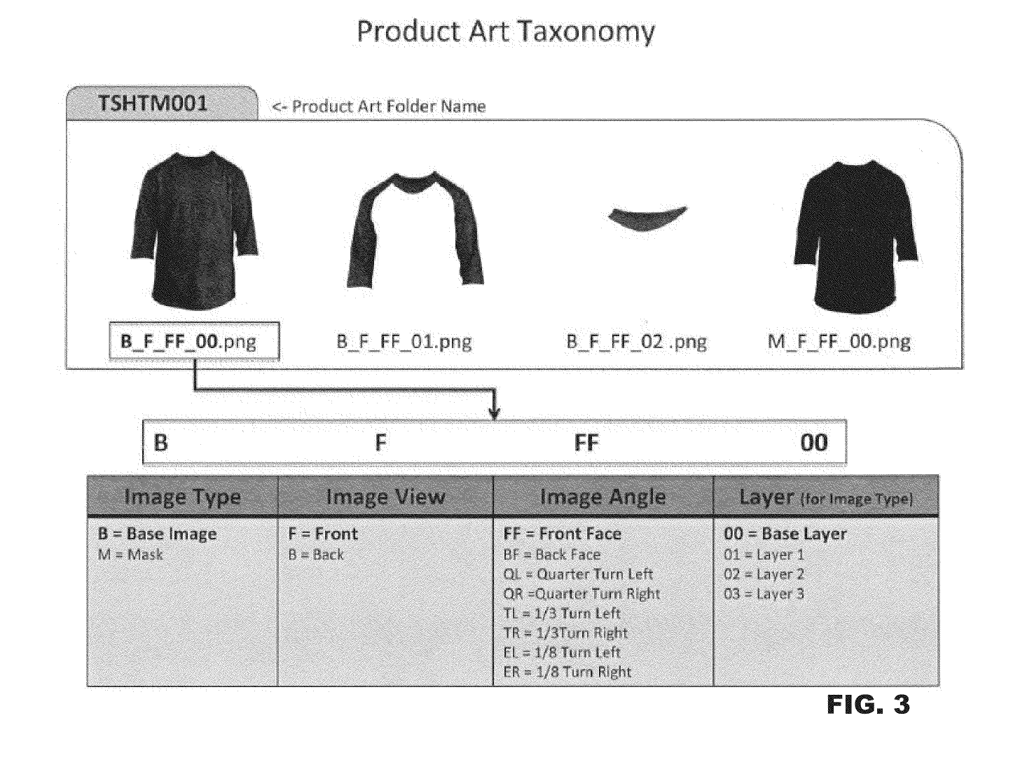

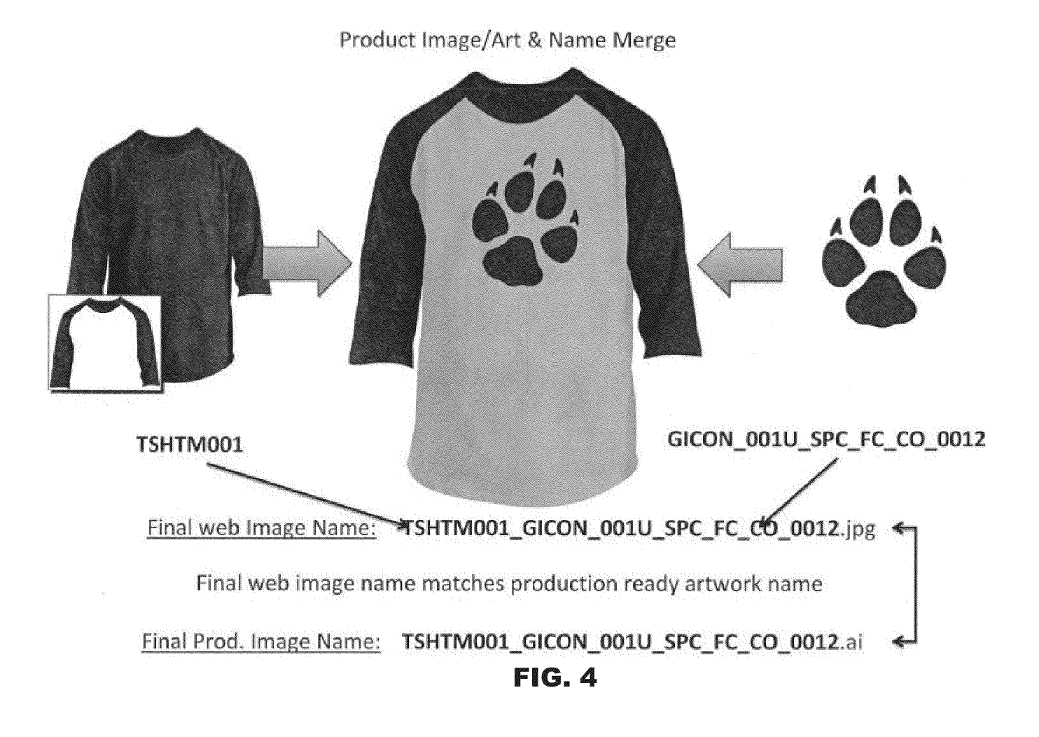

FIGS. 3 and 4 illustrates how the product represented by a filename can be derived from a product image file name, according to an embodiment of a naming scheme.

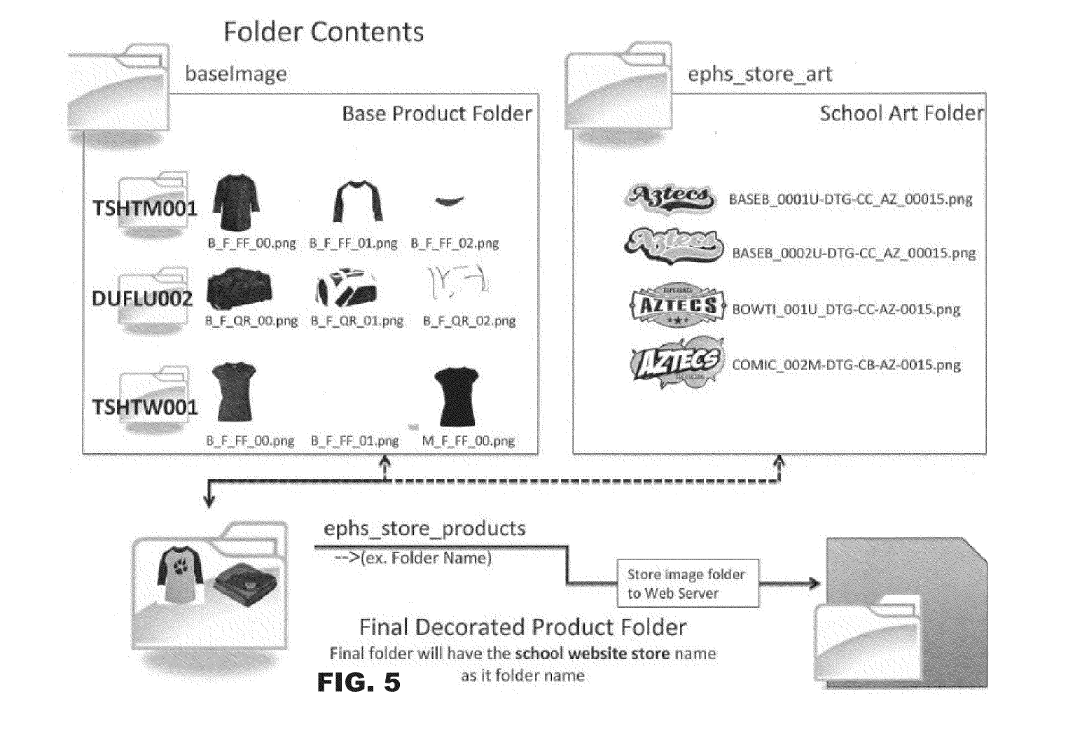

FIG. 5 illustrates a process for creating and storing custom product images, according to an embodiment. Base product images are stored in a “base image” folder. The “base image” folder can be shared by (e.g., serve images to) all stores generated and hosted by the system. Each store can have its own store art folder, which may be named to reflect the organization associated with the store or otherwise be associated with the store (e.g., via a row in a database table). To create custom product images for a given store, the system can retrieve selected base product images from the “base image” folder. The system can then combine these selected base product images with art from the store's associated art folder to generate the custom images of the selected products. These custom images can then be stored in a folder on a web server hosting or accessible by the storefront. In an embodiment, the folder can be named to reflect the organization associated with the store or otherwise be associated with the store.

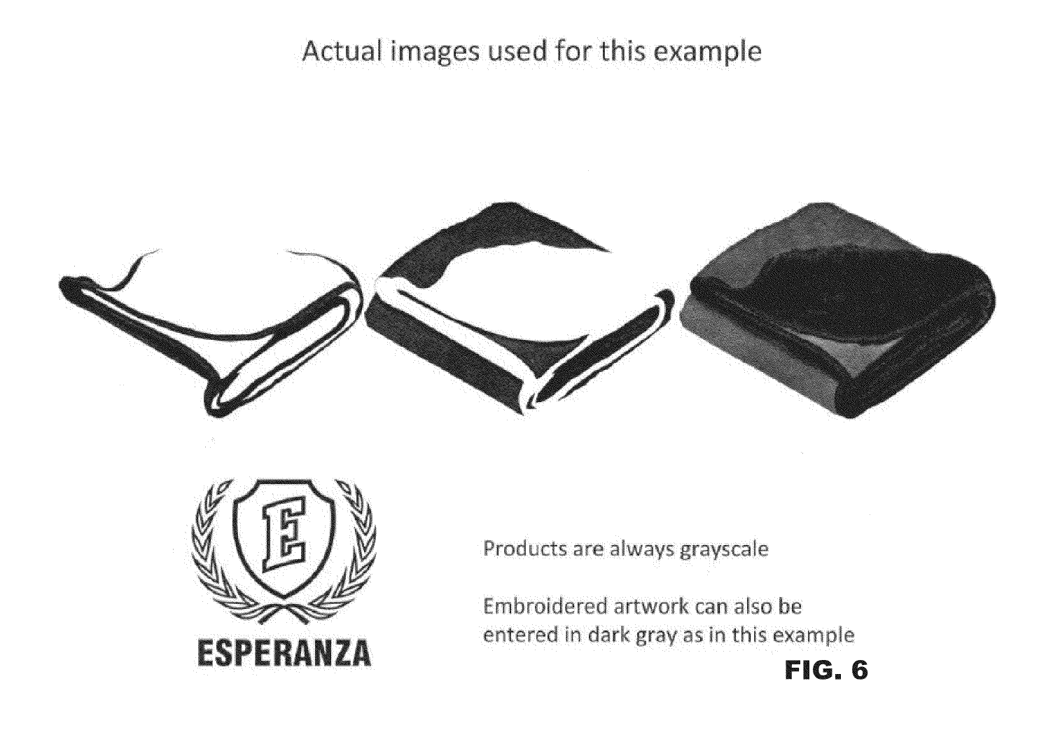

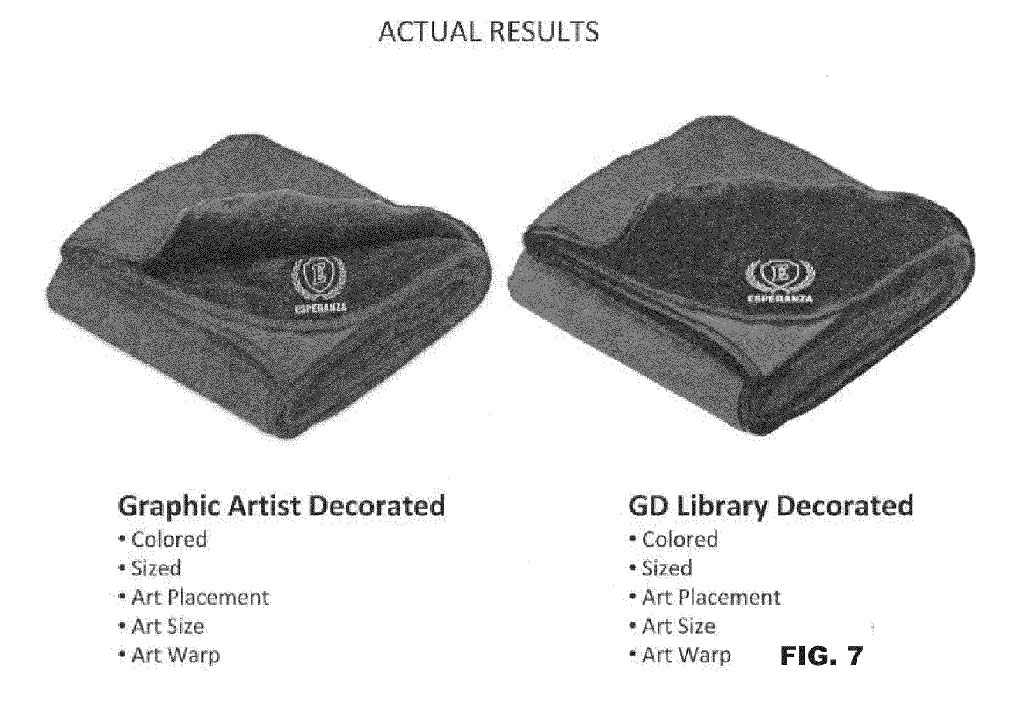

FIGS. 6 and 7 illustrate how a base product image can be combined with an art option to generate a custom product image, according to an embodiment. The product images and artwork can be stored as gray scale images. The system can combine the product images and the artwork, including coloring the images, sizing the images, placing the art on the image, sizing the art, warping the art, and the like. As can be seen in FIG. 7, the resulting custom product image, which is automatically generated by the system without human intervention, is comparable to the image that can be created by a graphic artist.

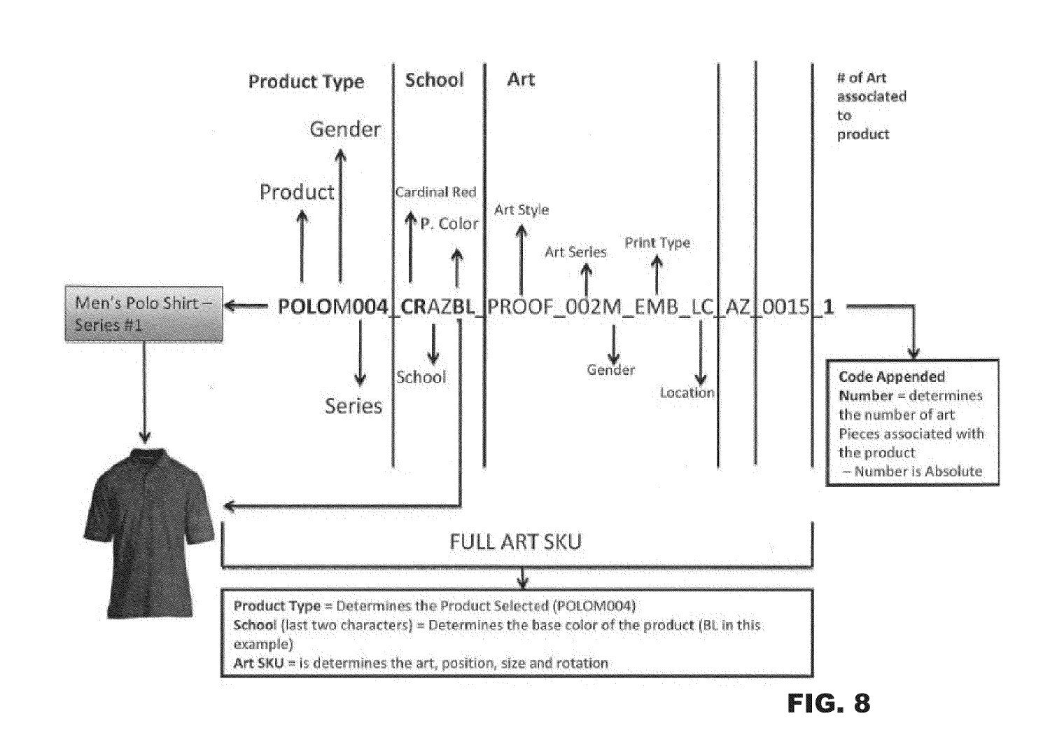

FIG. 8 illustrates a naming scheme that can be used by the system, according to an embodiment. As shown, the name of files (e.g., images) and directories/folders can comprise multiple name components, which may be separated by a delimiter (e.g., underscore character), or which may be fixed length. Each of the plurality of name components can comprise a code that associates the file or directory with a particular attribute, such as a product, gender, series, organization, organization color, art style, art series, art gender, print type, location, and/or the number of art pieces associated with the product. At least a subset of the plurality of name components (i.e., a portion of the file or directory name) together can comprise the SKU of a store product. In an embodiment, the SKU is comprised of the product, gender, series, organization, organization color, art style, art series, art gender, print type, and location.

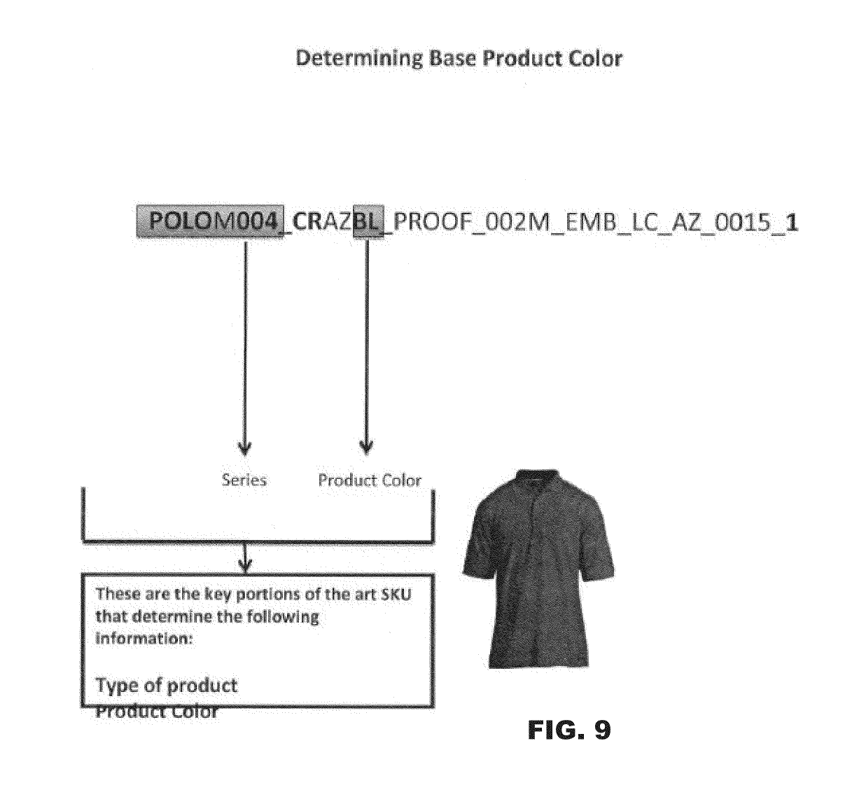

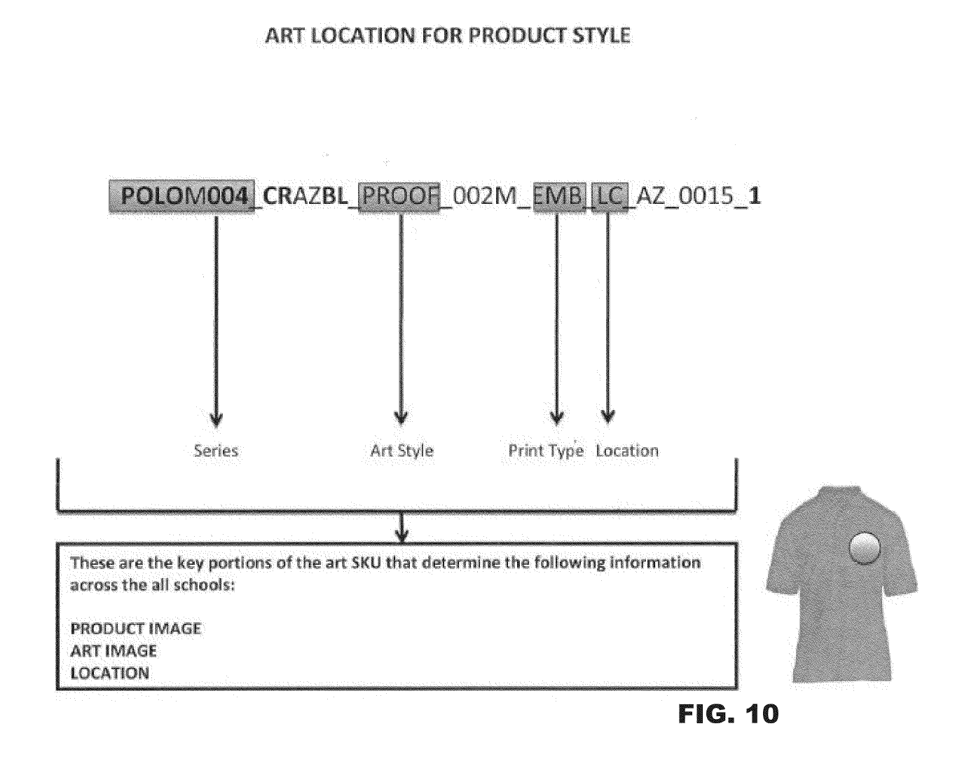

Other subsets of the name components can be used by the system for other determination. For instance, as shown in FIGS. 9-10, portions of the file or directory name can be used to determine the type of product, product color, product image, art image, location, etc.

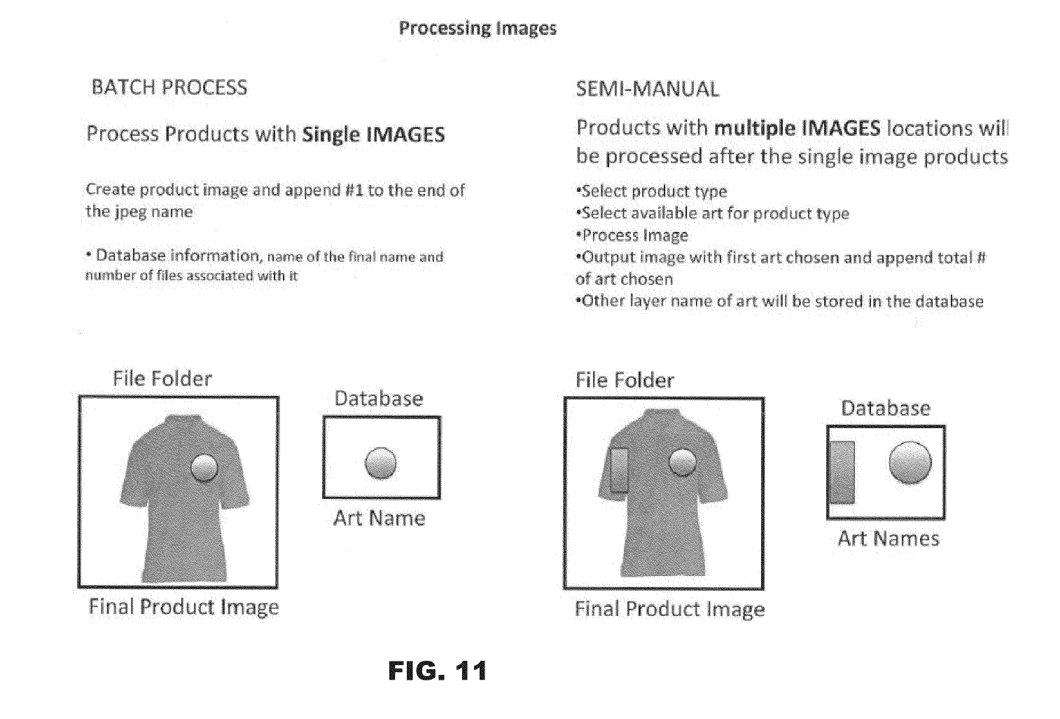

FIG. 11 illustrates a method for processing base product images and art objects to create product images for storefronts, according to an embodiment.

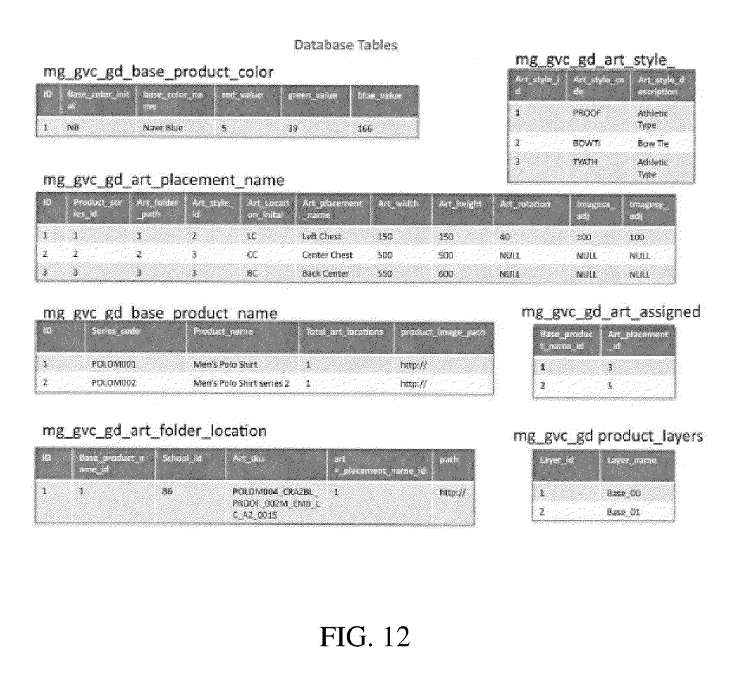

FIG. 12 illustrates a set of example database tables, according to an embodiment. Each of the tables comprises one or more rows comprising data related to products, art, etc.

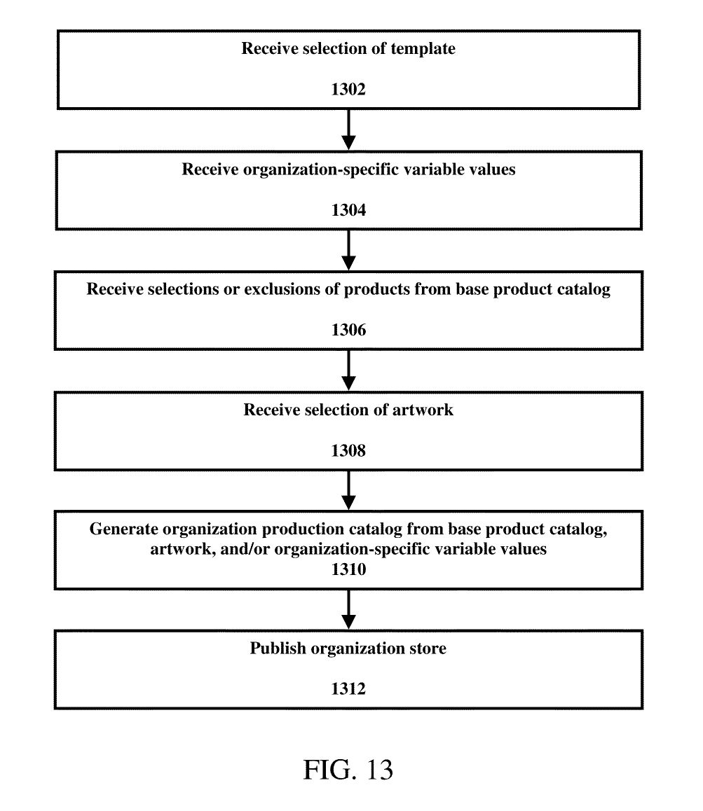

FIG. 13 illustrates a method for creating a custom online store for an organization, according to an embodiment. At step 1302, the system receives a selection of a template of an online store. The template may be specific to a certain type of organization (e.g., a school). Alternatively, the online store may be created from scratch, without the benefit of a template. In step 1304, values are received for organization-specific variables, such as colors, contact information (e.g., email address, phone number, address), etc. The values may comprise images as well, such as a logo or other branding. In the event that a value is not specified for a given variable, a default value may be used. In step 1306, products are selected from a base product catalog or excluded from a default store catalog generated automatically from the base product catalog. It should be understood that whether selection of products works by inclusion or exclusion is a design choice. In step 1308, artwork for the products is selected. This artwork may be created by the organization or by operators of the system. In step 1310, the system generates an organization-specific product catalog using the products from the base product catalog, the selected or generated artwork, and/or organization-specific variables received in step 1304. In step 1312, once the product catalog has been generated, the custom online store is generated for the organization and published. Once the online store is published it is accessible via at least one network, which may include the Internet. The system can comprise a web server which serves web pages associated with the online store. The web pages may be static or dynamically generated, or comprise a combination of static and dynamically generated web pages. For example, the product pages may comprise static portions which are shared across all organizations (e.g, navigation menus) as well as dynamic portions that are specific to an organization (e.g., colors, product images, product names, etc.). When a catalog page for a particular organization is requested, the system may dynamically generate the web pages by combining the static portions and dynamic portions, and serving the dynamically-generated page to the requestor via the at least one networks.

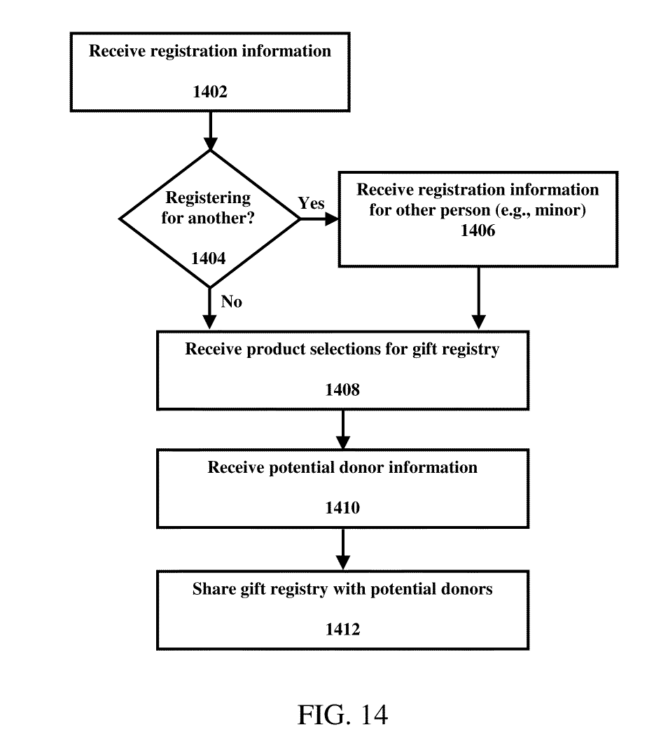

FIG. 14 illustrates a method for registering with the system, according to an embodiment. In step 1402, the system receives registration information from the registrant. The registration information may comprise authentication information (e.g., username/email and password), as well as personal information (e.g., name, contact information, etc.). In step 1404, the type of registration is determined. If the registrant is registering for another person (e.g., a parent registering for a child), in step 1406, the system can prompt the registrant for additional registration information related to the other person (e.g., separate authentication information, name, contact information, etc.). Once the registration information has been received, the registrant can be prompted to create a gift registry. The registrant may be provided with a user interface with inputs for selecting one or more products from an organization's store catalog to add to the registry. The registrant can interact with the inputs to select one or more products, and the selections are received by the system in step 1408. In step 1410, the system can prompt the registrant to enter donor information, and receive the donor information in response to the registrant's interactions with a user interface. The donor information may comprise a selection of a donor (e.g., from a list of previously registered donors) or personal information corresponding to a new donor (e.g., email address, name, etc.) In step 1412, the gift registry can be shared with one or more of the donors identified in step 1410. Step 1412 can comprise sending notification (e.g., email) to the identified donors or posting the gift registry or a link to the gift registry (e.g., with a description of the gift registry) to an online social networking site (e.g., Facebook).

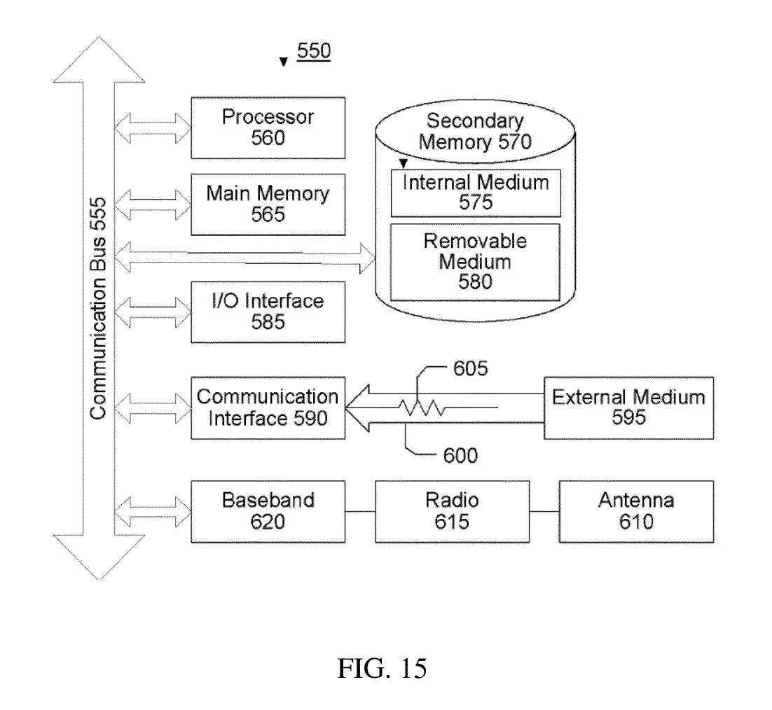

FIG. 15 is a block diagram illustrating an example wired or wireless system 550 that may be used in connection with various embodiments described herein. For example the system 550 may be used as or in conjunction with one or more of the modules, as previously described above. The system 550 can be a conventional personal computer, computer server, personal digital assistant, smart phone, tablet computer, vehicle navigation and/or control system, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as one or more of the modules discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for implementing an online teacher gift registry, the method comprising:
generating a teacher registration graphical user interface;
entering teacher registration information prompted by a registration module;
selecting, from an online store, products and a quantity of each of the selected products to be included in the teacher gift registry for others to purchase; and
electronically publishing registry information,
wherein the electronically published registry information includes a uniform resource locator (URL) link enabling others to access the teacher gift registry.
The method of claim 1, further comprising generating a graphical user interface configured to permit a user to search for a specific teacher entry in the teacher gift registry based on at least one of a teacher's name and a name of the teacher's school.

2. The method of claim 1, wherein the products selected from the online store are associated with one of a classroom supplies list and a student required supplies list.

3. The method of claim 2, further comprising creating a contact list comprising contact information for at least one of persons associated with the teacher, persons associated with students taught by the teacher, and persons associated with a school at which the teacher teaches,
wherein the registry information including the URL link to access the online teacher gift registry is electronically published via email to email addresses included in the contact list.

4. The method of claim 2, further comprising generating a teacher gift registry user interface which is displayed to a person accessing the teacher gift registry and comprises the products associated with the classroom supplies list and the student required supplies list as selected from the online store by the teacher,
wherein through the teacher gift registry user interface the person selects one or more products from the classroom supplies list and the student required supplies list and a quantity of each product for purchase, and
wherein the purchased products are automatically provided to the teacher.

5. The method of claim 4, further comprising generating a graphical user interface configured to permit a user to search for a specific teacher entry in the teacher gift registry based on at least one of a teacher's name and a name of the teacher's school.

6. The method of claim 4, wherein the teacher gift registry user interface comprises a select-all choice associated with each of the classroom supplies list and the student required supplies list which permits the person to select for purchase one of each product included in the list associated with the select-all choice.

7. The method of claim 4, wherein the displayed quantity of a product is decremented by an amount corresponding to a purchased quantity and if the quantity reaches zero the product is removed from display.

8. The method of claim 4, wherein the purchased products are automatically identified for delivery to an address specified by the teacher during registration.

9. The method of claim 1, further comprising publishing via at least one of social media or web page, names of persons who purchase products through the teacher gift registry.

10. The method of claim 1, further comprising implementing a program which awards points redeemable in the teacher gift registry to persons who purchase products through the teacher gift registry.

11. A system for implementing an online teacher gift registry, the system comprising:
a processor which generates a teacher registration graphical user interface;
a registration module which inputs teacher registration information;
a communications module which communicates with an online store; and
a web server which electronically publishes registry information,
wherein products and a quantity of each of the products are selected from the online store and listed in the teacher gift registry for others to purchase, and
wherein the wherein the electronically published registry information includes a uniform resource locator (URL) link enabling others to access the teacher gift registry.

12. The system of claim 11, wherein the products selected from the online store are associated with one of a classroom supplies list and a student required supplies list.

13. The system of claim 12, further comprising contact list creation module which creates a contact list comprising contact information for at least one of persons associated with the teacher, persons associated with students taught by the teacher, and persons associated with a school at which the teacher teaches,
wherein the registry information including the URL link to access the online teacher gift registry is electronically published via email to email addresses included in the contact list.

14. The system of claim 12, further comprising a teacher registry module which generates a teacher gift registry user interface which is displayed to a person accessing the teacher gift registry and comprises the products associated with the classroom supplies list and the student required supplies list as selected from the online store by the teacher,
wherein through the teacher gift registry user interface the person selects one or more products from the classroom supplies list and the student required supplies list and a quantity of each product for purchase, and
wherein the purchased products are automatically provided to the teacher.

15. The method of claim 14, wherein the teacher registry module generates a graphical user interface configured to permit a user to search for a specific teacher entry in the teacher gift registry based on at least one of a teacher's name and a name of the teacher's school.

16. The system of claim 14, wherein the teacher gift registry user interface comprises a select-all choice associated with each of the classroom supplies list and the student required supplies list which permits the person to select for purchase one of each product included in the list associated with the select-all choice.

17. The method of claim 16, wherein the teacher registry module decrements a displayed quantity of a product by an amount corresponding to a purchased quantity and if the quantity reaches zero the product is removed from display.

18. The system of claim 14, wherein the teacher registry module identifies the purchased products for delivery to an address specified by the teacher during registration.

19. The system of claim 14, wherein the teacher registry module is configured to publish via at least one of social media or web page, names of persons who purchase products through the teacher gift registry.

20. The system of claim 14, wherein the teacher registry module is configured to implement a program which awards points redeemable in the teacher gift registry to persons who purchase products through the teacher gift registry.
